(19) United States
(12) Patent Application Publication
(10) Pub. No.: US 2007/0211719 A1
(43) Pub. Date: Sep. 13, 2007

(54) Dynamic payload header suppression in a wireless communication system

(75) Inventors: Thomas L. Johnson, Gainesville, GA (US); David M. Pullen, Hayesville, NC (US); Margo E. Dolas, Alpharetta, GA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/797,614

(22) Filed: May 4, 2007

Related U.S. Application Data
(63) Continuation of application No. 11/436,572, filed on May 19, 2006.
(60) Provisional application No. 60/683,296, filed on May 23, 2005.

(51) Int. Cl. H04L 12/56

(52) U.S. Cl. 370/389

(57) ABSTRACT

In a wireless communication system, dynamic payload header suppression (DPHS) is applied to a data stream to reduce header overhead. DPHS allows the suppression of static fields as well as fields that change in a predictable manner (i.e., predictably dynamic fields). To suppress predictably dynamic fields, delta encoding is utilized to enable a cable modem to replace a dynamic field with information indicating how the field is different from the same field in a previous packet in the data stream. DPHS constructs a suppression mask by using a special packet called a “learn” packet. The “learn” packet is a copy of the original packet with extra bytes that guide the suppression process. It indicates that both the sending and receiving entities are to take a full copy of a packet header, which is then used as a reference to reconstruct the suppressed fields.

### CROSS-REFERENCE TO RELATED APPLICATIONS

The present application is a continuation of U.S. patent application Ser. No. 11/436,572, filed May 19, 2006, which claims the benefit of U.S. Provisional Patent Application No. 60/683,296, filed on May 23, 2005, both of which are expressly incorporated herein by reference in their entireties.

The following United States patent applications have a common assignee and contain some common disclosure:

“Cable Modem System and Method for Dynamically Mixing Protocol Specific Header Suppression Techniques,” U.S. patent Ser. No. 09/973,781, filed Oct. 11, 2001, by Bunn et al., still pending, incorporated herein by reference in its entirety;

“Cable Modem System and Method for Supporting Packet PDU Data Compression,” U.S. patent Ser. No. 09/973,783, filed Oct. 11, 2001, by Bunn et al., still pending, incorporated herein by reference in its entirety;

“Dynamic Delta Encoding for Cable Modem Header Suppression,” U.S. patent Ser. No. 09/973,871, filed Oct. 11, 2001, by Bunn et al., still pending, incorporated herein by reference in its entirety;

“Efficiently Transmitting RTP Protocol in a Network that Guarantees In Order Delivery of Packets,” U.S. patent Ser. No. 09/973,872, filed Oct. 11, 2001, by Bunn et al., still pending, incorporated herein by reference in its entirety;

“Cable Modem System and Method for Supporting Extended Protocols,” U.S. patent Ser. No. 09/973,875, filed Oct. 11, 2001, by Bunn et al., still pending, incorporated herein by reference in its entirety; and

“Method, System, and Computer Program Product for Suppression Index Reuse and Packet Classification for Payload Header Suppression,” U.S. patent Ser. No. 10/192,654, filed Jul. 11, 2002, by Saladino et al., still pending, incorporated herein by reference in its entirety.

### BACKGROUND OF THE INVENTION

1. Field of the Invention

The present invention relates generally to communication networking, and more specifically to managing the transmission of traffic across a wireless communication network.

2. Related Art

Conventional cable communications systems deploy a cable modem headend (e.g., cable modem termination system (CMTS) for a headend controller) that manages communications with a plurality of cable modems. The headend defines the upstream and downstream operating characteristics that enable the cable modems to send carrier signals upstream to the headend and receive signals from the headend in the downstream. The upstream may consist of multiple channels that can be assigned to the cable modems. These channels are separated from each other by operating at different frequencies. However, the downstream typically consists of a single broadcast channel.

In a communication system, payload header suppression can be applied to data packets within a data stream to reduce header overhead by suppressing static header fields to increase transmission speed and more efficiently use limited bandwidth. Certain header fields, however, are dynamic in that they may change from packet to packet within a data stream.

What are needed are methods to suppress dynamic header fields.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art(s) to make and use the invention. In the drawings, like reference numbers indicate identical or functionally similar elements. Additionally, the leftmost digit(s) of a reference number identifies the drawing in which the reference number first appears.

FIG. 1 illustrates a TCP/IPv4/DIX Packet.

FIG. 2 illustrates a DPHS TCP/IPv4 Learn Packet, according to an embodiment of the invention.

FIG. 3 illustrates a DPHS TCP/IPv4 Suppressed Packet, according to an embodiment of the invention.

FIG. 4 illustrates a TCP/IPv6/DIX Packet.

FIG. 5 illustrates a DPHS TCP/IPv6 Learn Packet, according to an embodiment of the invention.

FIG. 6 illustrates a DPHS TCP Learn Packet with IPv6 Header Suppressed, according to an embodiment of the invention.

FIG. 7 illustrates a DPHS TCP/IPv6 Suppressed Packet, according to an embodiment of the invention.

FIG. 8 illustrates a DPHS TCP/IPv6 Suppressed Packet for Middle/Last Fragment, according to an embodiment of the invention.

FIG. 9 illustrates a IPv6/DIX Packet.

FIG. 10 illustrates a DPHS IPv6 Learn Packet, according to an embodiment of the invention.

FIG. 11 illustrates a DPHS IPv6 Suppressed Packet, according to an embodiment of the invention.

FIG. 12 illustrates another DPHS IPv6 Learn Packet, according to an embodiment of the invention.

FIG. 13 illustrates another DPHS IPv6 Suppressed Packet, according to an embodiment of the invention.

FIG. 14 illustrates a RTP/UDP/IPv4/DIX Packet.

FIG. 15 illustrates a DPHS RTP Learn Packet, according to an embodiment of the invention.

FIG. 16 illustrates a DPHS Suppressed RTP Packet, according to an embodiment of the invention.

FIG. 17 provides a signaling diagram that illustrates the initiation process to enable DPHS with TCP protocol, according to an embodiment of the invention.

FIG. 18 provides a flowchart of a method for transmitting suppressed packets from the perspective of the CM, according to an embodiment of the invention.

FIG. 19 provides a flowchart of method for receiving suppressed packets from the perspective of the CMTS, according to an embodiment of the invention.

FIG. 20 provides signaling diagram that illustrates the initiation process to enable DPHS with RTP protocol, according to an embodiment of the invention.

FIG. 21 illustrates an operational flow of DPHS, according to an embodiment of the invention.

FIG. 22 illustrates a second operational flow of DPHS, according to an embodiment of the invention.

FIG. 23 illustrates a third operational flow of DPHS, according to an embodiment of the invention.

FIG. 24 illustrates a fourth operational flow of DPHS, according to an embodiment of the invention.

FIG. 25 illustrates a fifth operational flow of DPHS, according to an embodiment of the invention.

FIG. 26 illustrates a sixth operational flow of DPHS, according to an embodiment of the invention.

FIG. 27 illustrates a seventh operational flow of DPHS, according to an embodiment of the invention.

FIG. 28 illustrates a eighth operational flow of DPHS, according to an embodiment of the invention.

FIG. 29 illustrates a ninth operational flow of DPHS, according to an embodiment of the invention.

FIG. 30 illustrates a tenth operational flow of DPHS, according to an embodiment of the invention.

FIG. 31 illustrates a eleventh operational flow of DPHS, according to an embodiment of the invention.

FIG. 32 illustrates a twelfth operational flow of DPHS, according to an embodiment of the invention.

FIG. 33 illustrates a thirteenth operational flow of DPHS, according to an embodiment of the invention.

FIG. 34 illustrates a fourteenth operational flow of DPHS, according to an embodiment of the invention.

### DETAILED DESCRIPTION OF THE INVENTION

This specification discloses one or more embodiments that incorporate the features of this invention. The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In a communications system (such as cable communications, wireless network, wireline network or a network including both wireless and wireline network elements), dynamic payload header suppression (DPHS) can be applied to a data stream to reduce header overhead (such as packets having IPv6/DIX headers, TCP/IPv6/DIX headers, TCP/IPv4/DIX headers, and RTP/UDP/IPv4/DIX headers). DPHS allows the suppression of static fields as well as dynamic fields that change in a predictable manner (i.e., predictably dynamic fields). To suppress predictably dynamic fields, delta encoding is utilized to enable a cable modem, or other source device, to replace a dynamic field with information indicating how the field is different from the same field in a previous packet in the data stream. DPHS constructs a suppression mask by using a special packet called a “learn” packet. The “learn” packet is a copy of the original packet with extra bytes that guide the suppression process. It indicates that both the sending and receiving entities are to take a full copy of the, for example, IPv6/DIX, TCP/IPv6/DIX, TCP/IPv4/DIX, or RTP/UDP/IPv4/DIX header and save it as the template header, which is then used as a reference to reconstruct the suppressed fields

1. Glossary

The following terms are defined so that they may be used to describe embodiments of the present invention. As used herein:

“Ethernet II/DIX”: The Ethernet Version 2 or Ethernet II frame, the so-called DIX frame (named after DEC, Intel, and Xerox). This term refers to the most common Ethernet Link Layer Protocol that is often used directly by the Internet Protocol. Ethernet II/DIX is comprised of 48-bit destination and source addresses, with a 2-byte type field. Ethernet II and DIX are used interchangeably, herein. (See RFC 894, RFC refers to Request For Comments that are provided by the Internet Engineering Task Force (“IETF”))

“DPHS”: Dynamic Payload Header Suppression. The delta-encoding mechanism used to suppress fields (bytes) of consecutive frames that change in a predictable manner. (See RFC1144).

“IP”: Internet Protocol.

“IPv4”: Version 4 of Internet Protocol (See RFC791).

“IPv6”: Version 6 of Internet Protocol (See RFC2460).

“PHS”: Payload Header Suppression as defined in DOCSIS 1.1/2.0. Also known as “static” payload header suppression. In general, this involves a suppression mask and a template header. Only bytes that do not change between consecutive input frames may be suppressed.

“PHSI”: Payload Header Suppression Index. A value (assigned by a cable modem termination system (“CMTS”)) which identifies the parameters and variables needed to reconstruct the suppressed fields of a suppressed payload header. For DPHS, the PHSI indirectly identifies the actions required by the cable modem (CM) to create a data stream which, when reconstructed by the CMTS, will result in the original input packet.

“RTP”: Real-Time Transport Protocol. A best-effort protocol using UDP as the underlying transport protocol. Used to send VoIP phone calls. (See RFC 1889).

“SID”: Service Identifier. This is the primary mechanism for identifying a particular upstream data stream from a specific CM.

“Template Header”: A copy of the payload header kept by both the suppressing and reconstructing ends. Suppressed fields (bytes) are reconstructed by taking bytes from the template header.

“TCP”: Transmission Control Protocol. A point-to-point, guaranteed-delivery protocol that is used as the underlying mechanism for FTP (File Transfer Protocol) and many others. In DPHS, this is specifically “non-encapsulated TCP/IP” (e.g. the IP packet can not be encapsulated inside any other protocol (802.1P/Q, SNAP, etc). (See RFC 761).

“TCP ACK”: A cumulative TCP Acknowledgement. This term refers to a TCP packet that has the ACK bit set in the flags portion of the TCP header and the Acknowledgement Number value indicates the Sequence Number being acknowledged. (See RFC791).

“UDP”: User Datagram Protocol. A best-effort delivery protocol encapsulated within the IP routing framework. (See RFC 768).

2. Overview

Dynamic Payload Header Suppression is a method of suppressing fields in certain types of protocol headers to improve bandwidth efficiency in the upstream. It uses “delta encoding” to suppress more bytes than Payload Header Suppression. It also provides on-the-fly header “learning” to configure more quickly rules for specific connections or sessions.

Payload Header Suppression, known as PHS or in the context of this application, as static suppression, takes advantage of the fact that during the life of a particular TCP connection or RTP session, certain fields will remain unchanged from one packet to the next. For example, when a user sends an email message, all TCP packets used to carry that message from the user's PC to the SMTP server will have the same source and destination IP addresses. There may also be other fields in the various protocol headers that do not change for the life of the connection (e.g., Ethernet source and destination addresses, TCP port numbers, and even length fields if the session in question is (for example) a phone call using a codec with fixed packet size).

PHS, as defined by DOCSIS 1.1/2.0, allows the CM and CMTS to agree on a “rule” by which the sender removes certain predetermined bytes from the packet before transmitting it to the receiver, which receives the suppressed packet and inserts bytes with predetermined values into the agreed-upon locations to restore the original packet. In PHS, the rule specifying the exact locations and values of bytes to be suppressed and later restored is determined in advance via registration or dynamic service messaging (e.g., dynamic service add, change and delete messages), and the values of the suppressed bytes never changes for the life of the rule.

Dynamic PHS, or “DPHS,” allows for more efficiency by suppressing not only static fields, but also fields which change in a predictable way over the life of the connection. One example of such a field is the RTP Sequence Number field, which increments by one for each successive RTP packet. Another example is the IPv4 Packet ID field, which IPv4 stack software often increments by either 0x0001 or 0x0100 from one packet to the next. DPHS can also suppress fields which change in a known manner but not necessarily by a known amount; for instance, the TCP Acknowledgement Number field will virtually always increase by some relatively small amount, though the exact amount of the increase may vary from one packet to the next.

To suppress predictably dynamic fields such as these and others, DPHS introduces the concept of “delta encoding.” In this approach, the CM replaces a dynamic field with information indicating how the field is different from the same field in the previous packet in the data stream. For instance, in the case of the TCP Acknowledgement Number field, the CM will remove that field from the packet before transmission, but it will indicate in a “control byte” (defined in detail below) that the field has been removed, and it will include a two-byte “delta” value which is to be added to the TCP Acknowledgement Number field of the most recent packet in the connection to get the value of the TCP Acknowledgement Number for the current packet. This saves 2 bytes relative to sending the entire 4-byte TCP Acknowledgement Number field.

To maximize bandwidth efficiency, DPHS is targeted at very specific types of packets using DIX protocol headers. In particular, DPHS targets IPv6/DIX headers, TCP/IPv6/DIX headers, TCP/IPv4/DIX headers, and RTP/UDP/IPv4/DIX headers.

In an embodiment, DPHS is adaptive in its construction of the suppression mask. This is especially critical in data applications and is accomplished using a special packet called a “learn” packet. The “learn” packet is a copy of the original packet with a few extra bytes that guide the suppression process. It indicates that both the sending and receiving entities are to take a full copy of the IPv6/DIX, TCP/IPv6/DIX, TCP/IPv4/DIX, or RTP/UDP/IPv4/DIX header and save it as the template header, which is then used as a reference to reconstruct the suppressed fields.

3. DPHS Packet Formats and Suppression

DPHS suppresses four types of headers, IPv6/DIX headers, TCP/IPv6/DIX headers, TCP/IPv4/DIX headers, and RTP/UDP/IPv4/DIX headers. Each of these headers uses the Learn packet, but both the Learn packet and the Suppressed packet differ for each header type. Each suppression instance is indexed by a PHSI. From the perspective of the CMTS, suppressed IP streams are identified by a PHSI.

All the IP headers targeted for suppression have three different sets of fields—static fields, connection static fields, and dynamic fields. Static fields, such as source and destination addresses, are those fields that do not change across many connections. Connection static fields, such as IPv6 Traffic Class or IPv4 Type of Service, are fields that do not change for the duration of a connection. Dynamic fields change during a connection; these include fields like TCP Sequence Number and TCP Acknowledgement Number. With delta encoding dynamic fields, as well as static fields can be suppressed.

3.1 TCP/IPv4/DIX

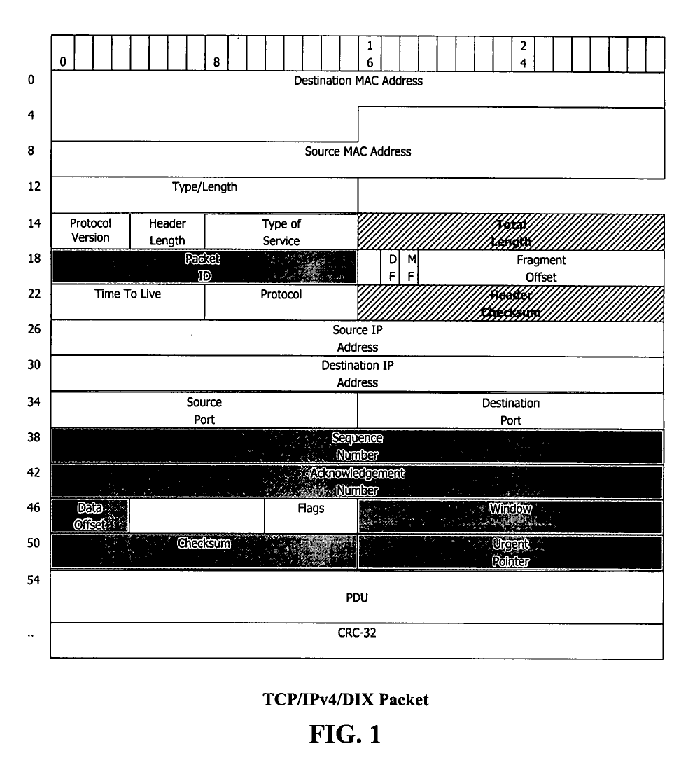

A full TCP/IPv4/DIX packet is illustrated in FIG. 1. The full TCP/IPv4/DIX packet contains 14 bytes of Ethernet II header, 20 bytes of IPv4 header, and 20 bytes of TCP header. If the IPv4 header contains options, the CM cannot perform DPHS on the packet.

The TCP/IPv4/DIX header contains static fields, connection static fields, and dynamic fields. The dynamic fields in the TCP/IPv4 header, delta encoded with DPHS, are shaded in FIG. 1. The dynamic Total Length and Header Checksum fields in the IPv4 header, diagonally shaded in FIG. 1, are not transmitted on the communications link, but regenerated by the CMTS from the unsuppressed header.

3.1.1 TCP/IPv4/DIX Control Bytes

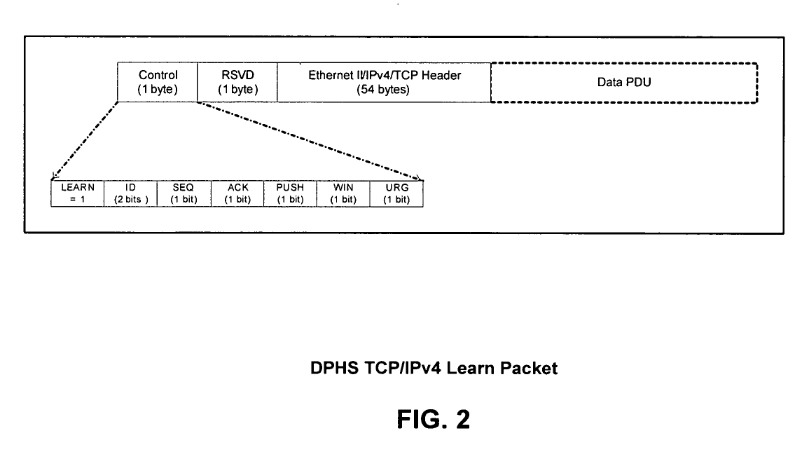

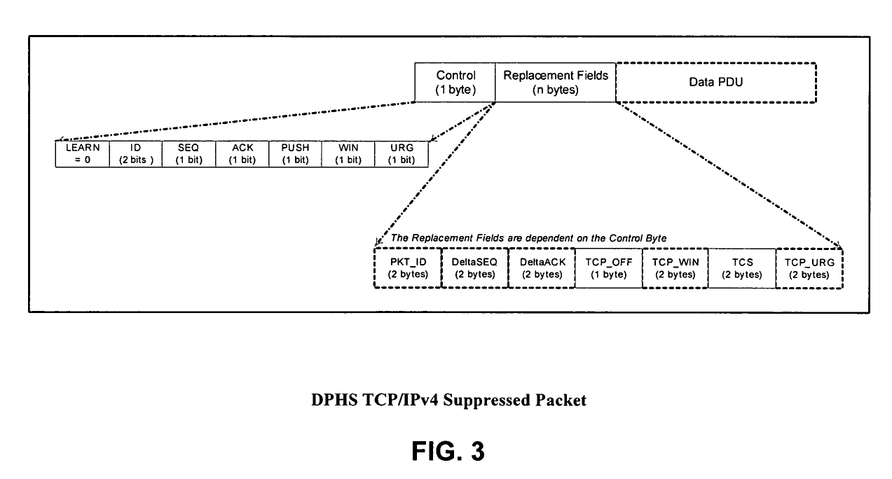

In an embodiment, the format of the DPHS TCP/IPv4 Learn Packet is shown in FIG. 2. Table 3-1 describes each of the fields within the learn packet. In an embodiment, the format of the DPHS TCP/IPv4 Suppressed Packet, including the prepended TCP Control Bytes is shown in FIG. 3. Tables 3-1 and 3-2 describe each of the fields within the TCP Control Bytes.

TABLE 3-1
DPHS TCP/IPv4 Control Byte Format

| Field | | Usage | Size |
|---|---|---|---|
| Learn | 1 = | The Learn bit indicates that the remainder | 1 bit |
| | | of the control byte can be ignored, and | |
| | | that an entire 54-byte DIX/IPv4/TCP header | |
| | | is included in the packet and should be | |
| | | used to replace the current template header. | |
| | | The second byte in the data stream is | |
| | | reserved and should be discarded. | |
| | 0 = | DPHS suppression has been applied. | |
| ID | 11 or | The two-byte delta field, PKT_ID, is a 2- | 2 bits |
| | 10 = | byte value to be copied to the IPv4 Packet | |
| | | ID field of the template header. | |
| | 01 = | Increment the IPv4 Packet ID Field of the | |
| | | template header by 0x0100. | |
| | 00 = | Increment the IPv4 Packet ID Field of the | |
| | | template header by 0x0001. | |
| SEQ | 1 = | This indicates that the next value in the | 1 bit |
| | | TCP Replacement Field is a 2-byte value to | |
| | | be added to the 4-byte TCP Sequence Number | |
| | | field of the template header. | |
| | 0 = | The TCP Sequence Number field of the | |
| | | template header should be used as is. | |
| ACK | 1 = | This indicates that the next value in the | 1 bit |
| | | TCP Replacement Field is a 2-byte value to | |
| | | be added to the 4-byte TCP Acknowledgement | |
| | | Number field of the template header. The | |
| | | result should be copied into the template | |
| | | header. | |
| | 0 = | The TCP Acknowledgement Number field of | |
| | | the template header should be used as is. | |
| PUSH | 1 = | The PUSH bit of the TCP Flags nibble | 1 bit |
| | | should be set and emitted. | |
| | 0 = | The PUSH bit of the TCP Flags nibble | |
| | | should be cleared and emitted. | |
| WIN | 1 = | This indicates that the next value in the | 1 bit |
| | | TCP Replacement Field is a 2-byte value | |
| | | to be copied to the TCP Window field of | |
| | | the template header. | |
| | 0 = | The TCP Window field of the template | |
| | | header should be used as is. | |
| URG | 1 = | This indicates that the next value in the | 1 bit |
| | | TCP Replacement Field is a 2-byte value | |
| | | to be copied to the TCP Urgent Pointer | |
| | | field of the template header. The TCP | |
| | | flags are also to be ORed with 0x20. | |
| | 0 = | The TCP Urgent Pointer field of the | |
| | | template header should be used as is. | |
| | | The TCP flags are to be ANDed with 0xdf. | |
| RSVD | | Reserved | 1 byte |

TABLE 3-2
DPHS TCP/IPV4 Replacement Field

| Field | Usage | Size |
|---|---|---|
| PKT_ID | The actual IPv4 Packet ID Field. This field | 2 bytes |
| | is sent only if the IPv4 Packet ID Field did | |
| | not increment by 0x0001 or 0x0100. | |
| DeltaSEQ | The difference between the previous TCP | 2 bytes |
| | Sequence Number and the current TCP Sequence | |
| | Number. This field is sent only if the | |
| | difference is non-zero. | |
| DeltaACK | The difference between the previous TCP | 2 bytes |
| | Acknowledgement Number and the current TCP | |
| | Acknowledgement Number. This field is sent | |
| | only if the difference is non-zero. | |
| TCP_OFF | The TCP Data Offset Byte. This field is | 1 byte |
| | always sent. | |
| TCP_WIN | The actual TCP Window Field. This field is | 2 bytes |
| | sent only if the difference between the | |
| | previous TCP Window Field and the current TCP | |
| | Window Field is non-zero. | |
| TCS | The TCP Header Checksum Field. This field is | 2 bytes |
| | always sent. | |
| TCP_URG | The actual TCP Urgent Pointer Field is sent | 2 bytes |
| | only if the IP Urgent Flag is set. | |

3.2 TCP/IPv6/DIX

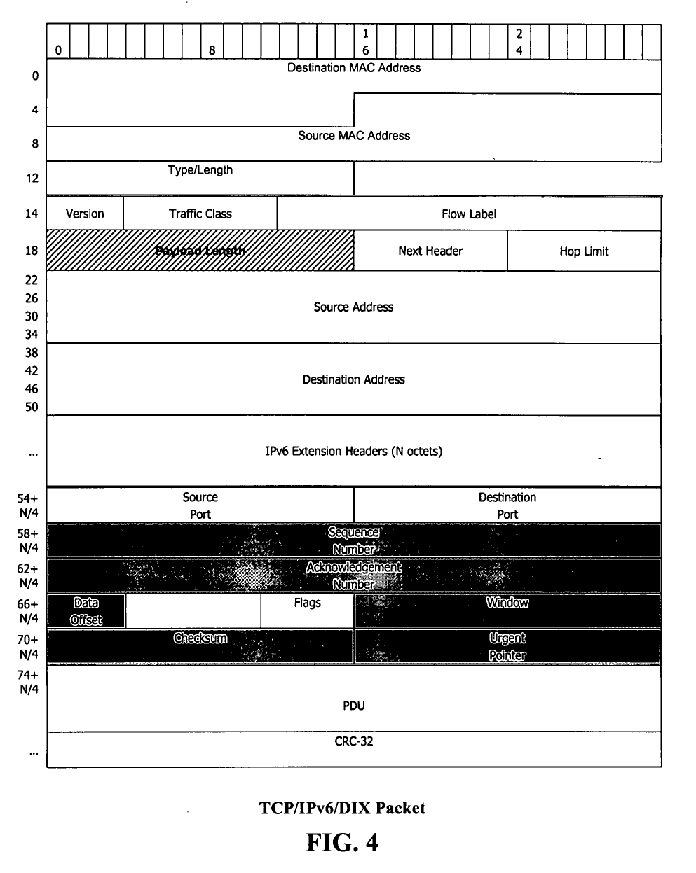

A full TCP/IPv6/DIX packet is illustrated in FIG. 4. The TCP/IPv6/DIX packet contains 14 bytes of Ethernet II header, 40 bytes of IPv6 header, possible bytes of IPv6 extension header(s), and 20 bytes of TCP header.

The TCP/IPv6/DIX header contains static fields, connection static fields, and dynamic fields. The dynamic fields in the TCP header, delta encoded with DPHS are shaded in FIG. 4. The dynamic Payload Length field in the IPv6 header, diagonally shaded in FIG. 4, is not transmitted on the communications link, but regenerated by the CMTS from the unsuppressed header. The Next Header field in the IPv6 header may be a static or dynamic field and is only transmitted on the link if it is dynamic.

3.2.1 TCP/IPv6/DIX Control Bytes

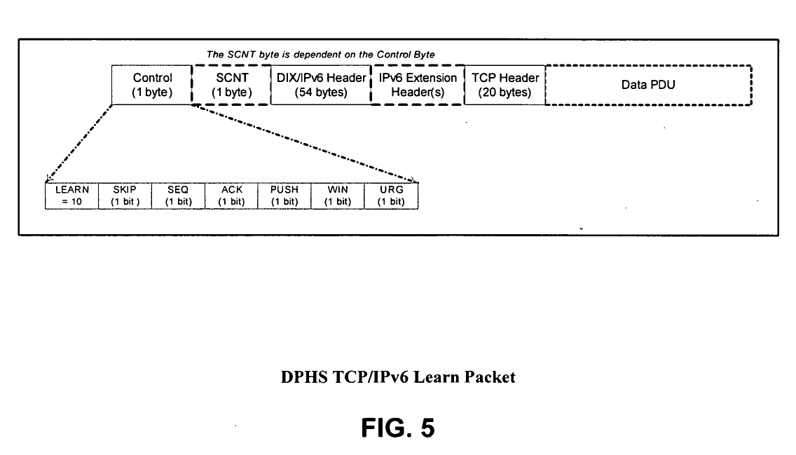

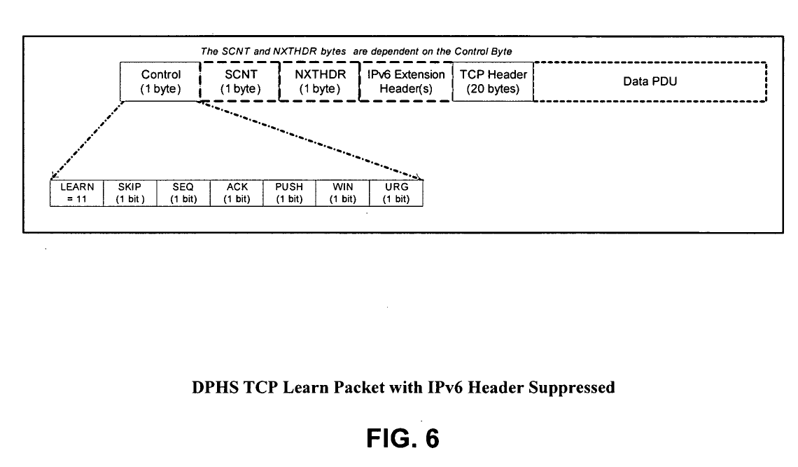

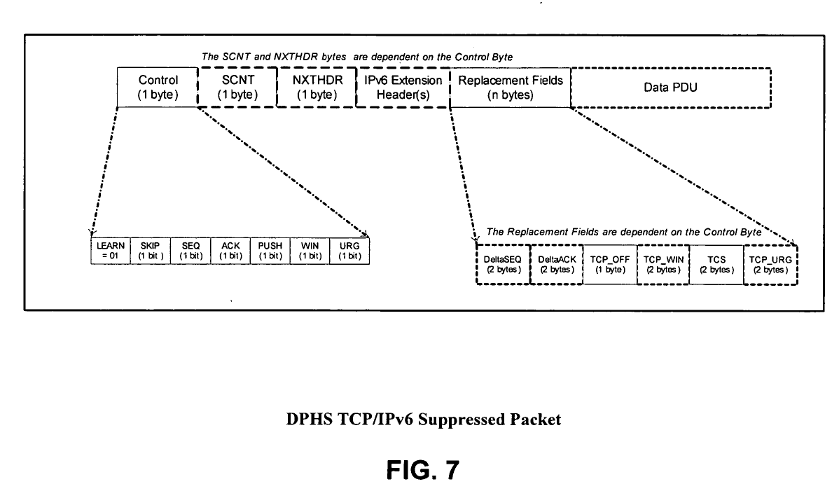

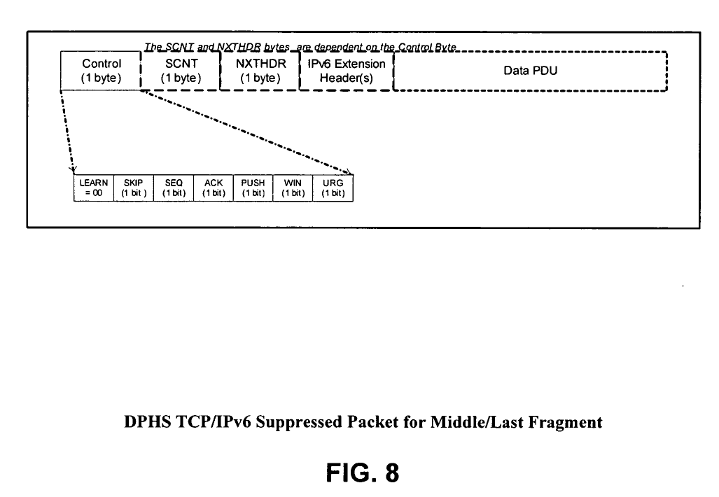

In an embodiment, the format of the DPHS TCP/IPv6 Learn Packet is shown in FIG. 5 and Table 3-3. In an embodiment, the format of the DPHS TCP/IPv6 Learn Packet with the IPv6 header suppressed is as shown in FIG. 6 and Table 3-3. In an embodiment, the format of the DPHS TCP/IPv6 Suppressed Packet, including the prepended TCP/IPv6 Control Bytes is shown in FIG. 7 and Tables 3-3, 3-4, and 3-5. In an embodiment, the format of the DPHS Middle/Last Fragment TCP/IPv6 Suppressed Packet is shown in FIG. 8 and Tables 3-3, 3-4, and 3-5.

TABLE 3-3
DPHS TCP/IPv6 Control Byte Format

| Field | | Usage | Size |
|---|---|---|---|
| Learn | 11 = | This indicates that a TCP header is included | 2 bits |
| | | in the packet which should be used to replace | |
| | | the current TCP template header. The bits in | |
| | | the Control Byte other than the SKIP bit | |
| | | should be ignored. | |
| | 10 = | This indicates that an entire DIX/IPv6/TCP | |
| | | header is included in the packet which should be | |
| | | used to replace the current template header. | |
| | | The bits in the Control Byte other than the | |
| | | SKIP bit should be ignored. | |
| | 01 = | This indicates that DPHS suppression has | |
| | | been applied; both IPv6 and TCP Headers are | |
| | | suppressed. No IPv6 Fragment Extension Header | |
| | | is present in the IPv6 Extended Header, or | |
| | | the IPv6 Fragment Extension Header is present | |
| | | and is the first IP fragment. | |
| | 00 = | DPHS suppression has been applied; only the | |
| | | IPv6 Header is suppressed. An IPv6 Fragment | |
| | | Extension Header is present and indicates | |
| | | that this is the middle or last fragment. | |
| SKIP | 1 = | IPv6 extension headers are present. The Next | 1 bit |
| | | Header field should be copied into the | |
| | | template header. The SCNT byte indicates the | |
| | | length of the extension headers that are to | |
| | | be sent unsuppressed. | |
| | 0 = | IPv6 extension headers are not present. | |
| SEQ | 1 = | This indicates that the next value in the TCP | 1 bit |
| | | Replacement Field is a 2-byte value to be | |
| | | added to the 4-byte TCP Sequence Number field | |
| | | of the template header. | |
| | 0 = | The TCP Sequence Number field of the template | |
| | | header should be used as is. | |
| ACK | 1 = | This indicates that the next value in the TCP | 1 bit |
| | | Replacement Field is a 2-byte value to be | |
| | | added to the 4-byte TCP Acknowledgement | |
| | | Number field of the template header. The | |
| | | result should be copied into the template | |
| | | header. | |
| | 0 = | The TCP Acknowledgement Number field of the | |
| | | template header should be used as is. | |
| PUSH | 1 = | The PUSH bit of the TCP Flags nibble should | 1 bit |
| | | be set and emitted. | |
| | 0 = | The PUSH bit of the TCP Flags nibble should | |
| | | be cleared and emitted. | |
| WIN | 1 = | This indicates that the next value in the TCP | 1 bit |
| | | Replacement Field is a 2-byte value to be | |
| | | copied to the TCP Window field of the | |
| | | template header. | |
| | 0 = | The TCP Window field of the template header | |
| | | should be used as is. | |
| URG | 1 = | This indicates that the next value in the TCP | 1 bit |
| | | Replacement Field is a 2-byte value to be | |
| | | copied to the TCP Urgent Pointer field of the | |
| | | template header. The TCP flags are also to be | |
| | | ORed with 0x20. | |
| | 0 = | The TCP Urgent Pointer field of the template | |
| | | header should be used as is. The TCP flags | |
| | | are to be ANDed with 0xdf. | |

TABLE 3-4
DPHS IPv6 Replacement Field

| Field | Usage | Size |
|---|---|---|
| SCNT | Skip Count. This field indicates the length of | 1 byte |
| | the IPv6 extension headers in units of octets. | |
| | This field is sent only if the SKIP bit is set to 1. | |
| NXTHDR | The Next Header field of the IPv6 header. This | 1 byte |
| | field is sent only if the SKIP bit is set to 1. | |

TABLE 3-5
DPHS TCP Replacement Field

| Field | Usage | Size |
|---|---|---|
| DeltaSEQ | The difference between the previous TCP | 2 bytes |
| | Sequence Number and the current TCP Sequence | |
| | Number. This field is sent only if the | |
| | difference is non-zero. | |
| DeltaACK | The difference between the previous TCP | 2 bytes |
| | Acknowledgement Number and the current TCP | |
| | Acknowledgement Number. This field is sent | |
| | only if the difference is non-zero. | |
| TCP_OFF | The TCP Data Offset Byte. This field is always | 1 byte |
| | sent. | |
| TCP_WIN | The actual TCP Window Field. This field is | 2 bytes |
| | sent only if the difference between the | |
| | previous TCP Window Field and the current TCP | |
| | Window Field is non-zero. | |
| TCS | The TCP Header Checksum Field. This field is | 2 bytes |
| | always sent. | |
| TCP_URG | The actual TCP Urgent Pointer Field is sent | 2 bytes |
| | only if the IP Urgent Flag is set. | |

3.3 IPv6/DIX

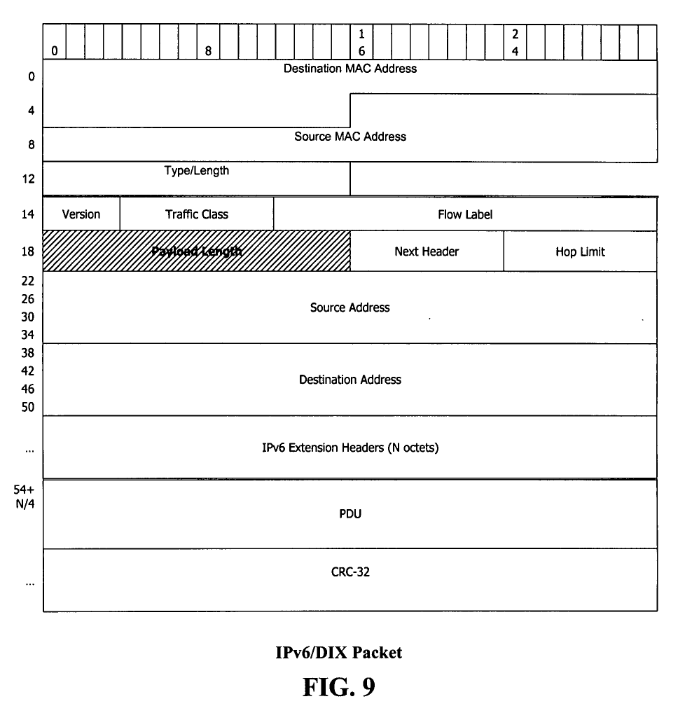

This section covers suppression of IPv6/DIX headers and specifically covers non-TCP IPv6 suppression. A full IPv6/DIX packet is illustrated in FIG. 9. The IPv6/DIX packet contains 14 bytes of Ethernet II header, 40 bytes of IPv6 header, and possible bytes of IPv6 extension header(s).

The IPv6/DIX header contains static fields, connection static fields, and dynamic fields. The Payload Length field in the IPv6 header, diagonally shaded in FIG. 9 is a dynamic field not transmitted on the communications link, but regenerated by the CMTS from the unsuppressed header. The Next Header field in the IPv6 header may be a static or dynamic field and is only transmitted on the link if it is dynamic.

There are two possible ways to implement the non-TCP IPv6 suppression. These are discussed in sections 3.3.1 and 3.3.2.

3.3.1 IPv6 Control Bytes—Option 1

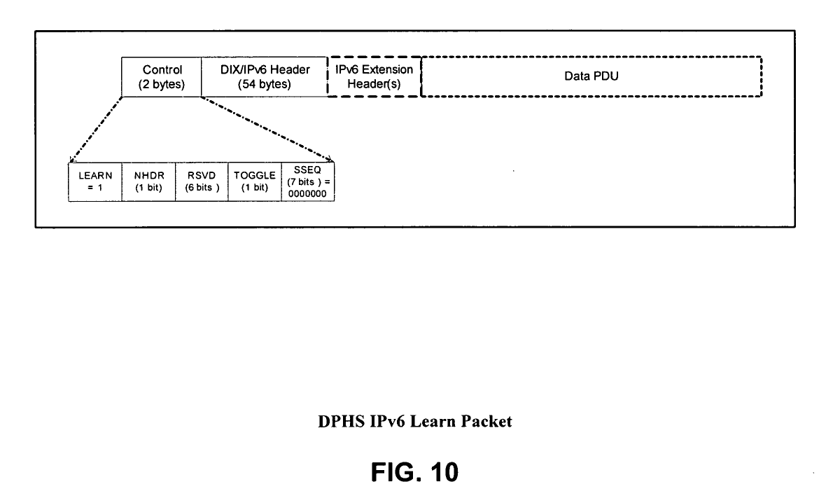

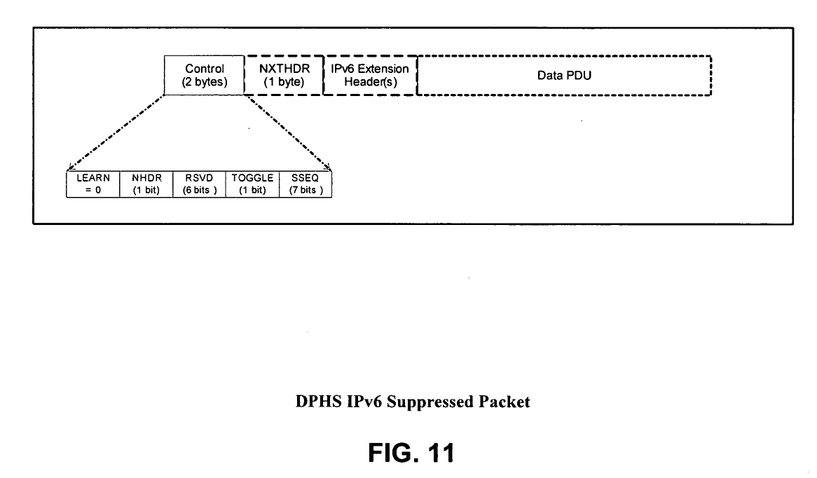

In an embodiment, the format of the DPHS IPv6 Learn Packet can be as shown in FIG. 10 and Table 3-6. The SSEQ field of the Learn Packet can be set to 0 in the DPHS IPv6 Learn Packet. In an embodiment, the format of the DPHS IPv6 Suppressed Packet, including the prepended IPv6 Control Bytes is shown in FIG. 11 and Tables 3-6 and 3-7.

The IPv6 Control Bytes include a 7-bit sequence number, SSEQ, and a toggle bit that the CMTS uses to detect when packets are lost so it can begin the recovery mechanism. The SSEQ field is incremented with each suppressed packet in the IPv6 data stream. When the CM reuses a PHSI for a new IPv6 stream, the TOGGLE bit will invert from its previous value.

The recovery mechanism is that the CMTS will send the CM a DSC message indicating that a suppressed packet was lost and as a result, the CM needs to send a Learn packet. This is discussed in sections 4 and 5.

TABLE 3-6
DPHS IPv6 Control Bytes Format

| Field | | Usage | Size |
|---|---|---|---|
| Learn | 1 = | An entire IPv6/DIX header is included in the | 1 bit |
| | | packet and should be used to replace the | |
| | | current template header. Note that only the | |
| | | first 40 bytes of the IPv6 header are | |
| | | considered when learning; Extension Headers | |
| | | are not learned. The rest of the bits in the | |
| | | Control byte should be ignored. | |
| | 0 = | DPHS suppression has been applied. | |
| NHDR | 1 = | This indicates that the Next Header field of | 1 bit |
| | | the IPv6 Header has changed and should be | |
| | | copied into the template header. | |
| | 0 = | This indicates that the Next Header field of | |
| | | the IPv6 Header has not changed. | |
| RSVD | | Reserved. | 6 bits |
| TOGGLE | | This bit is toggled upon every re-usage of a | 1 bit |
| | | PHSI. | |
| SSEQ | | This field is the sequence number of the | 7 bits |
| | | suppressed header. When the Learn bit is one, | |
| | | this number must be zero. When the Learn bit | |
| | | is zero, this number increments with each | |
| | | suppressed header in an IPv6 session. This | |
| | | counter will rollover. | |

TABLE 3-7
DPHS IPv6 Replacement Field

| Field | Usage | Size |
|---|---|---|
| NXTHDR | The Next Header field of the IPv6 header. This field | 1 byte |
| | is sent only if the NHDR bit of the Control byte is | |
| | set to 1. | |

3.3.2 IPv6 Control Bytes—Option 2

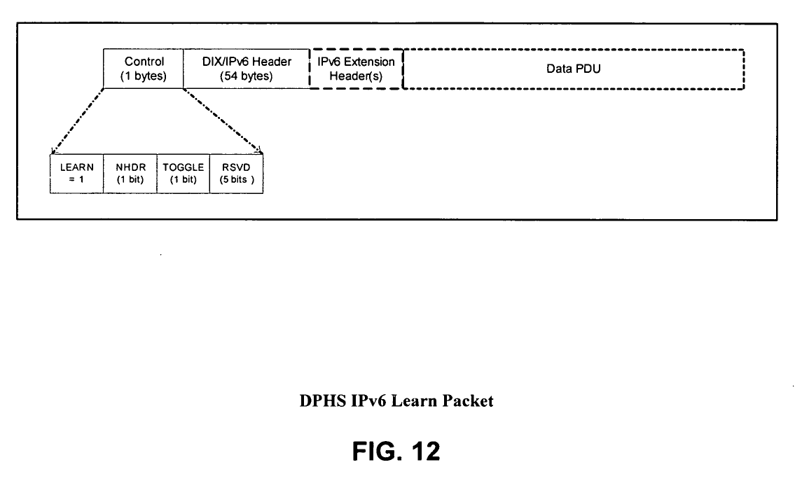

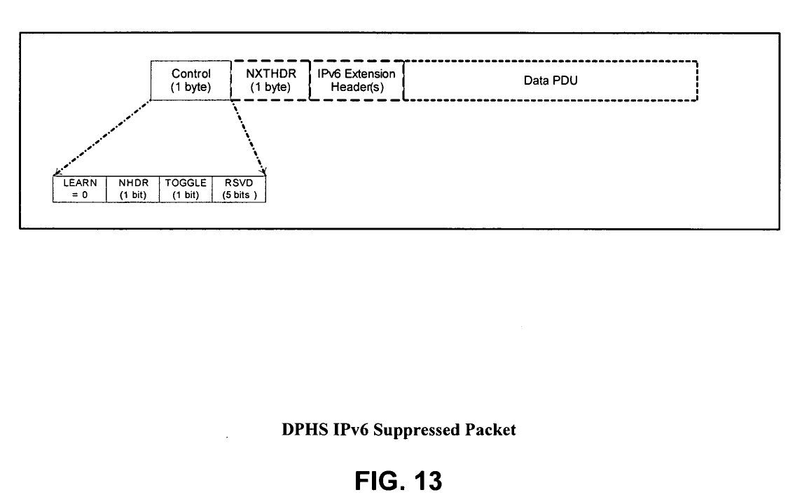

In an embodiment, the format of the DPHS IPv6 Learn Packet can be as shown in FIG. 12 and Table 3-8. In an embodiment, the format of the DPHS IPv6 Suppressed Packet, including the prepended IPv6 Control Byte, is shown in FIG. 13 and Tables 3-8 and 3-9.

The IPv6 Control Bytes includes a TOGGLE bit that the CMTS uses to detect when a Learn packet is lost so it can begin the recovery mechanism. The CM can invert the TOGGLE bit every time that it sends a Learn packet. The CMTS detects that a Learn packet has been lost if it receives a packet with the TOGGLE bit inverted in which the Learn bit is zero.

The recovery mechanism is that the CMTS will send the CM a DSC message indicating that a suppressed packet was lost and as a result, the CM needs to send a Learn packet. This is discussed in sections 4 and 5.

TABLE 3-8
DPHS IPv6 Control Bytes Format

| Field | | Usage | Size |
|---|---|---|---|
| Learn | 1 = | An entire IPv6/DIX header is included in | 1 bit |
| | | the packet and should be used to replace | |
| | | the current template header. Note that only | |
| | | the first 40 bytes of the IPv6 header are | |
| | | considered when learning; Extension Headers | |
| | | are not learned. The rest of the bits in | |
| | | the Control byte should be ignored. | |
| | 0 = | DPHS suppression has been applied. | |
| NHDR | 1 = | This indicates that the Next Header field | 1 bit |
| | | of the IPv6 Header has changed and should | |
| | | be copied into the template header. | |
| | 0 = | This indicates that the Next Header field | |
| | | of the IPv6 Header has not changed. | |
| TOGGLE | | This bit is toggled every time the Learn | 1 bit |
| | | bit is set to 1. | |
| RSVD | | Reserved. | 5 bits |

TABLE 3-9
DPHS IPv6 Replacement Field

| Field | Usage | Size |
|---|---|---|
| NXTHDR | The Next Header field of the IPv6 header. This | 1 byte |
| | field is sent only if the NHDR bit of the Control | |
| | byte is set to 1. | |

3.4 RTP/UDP/IPv4/DIX

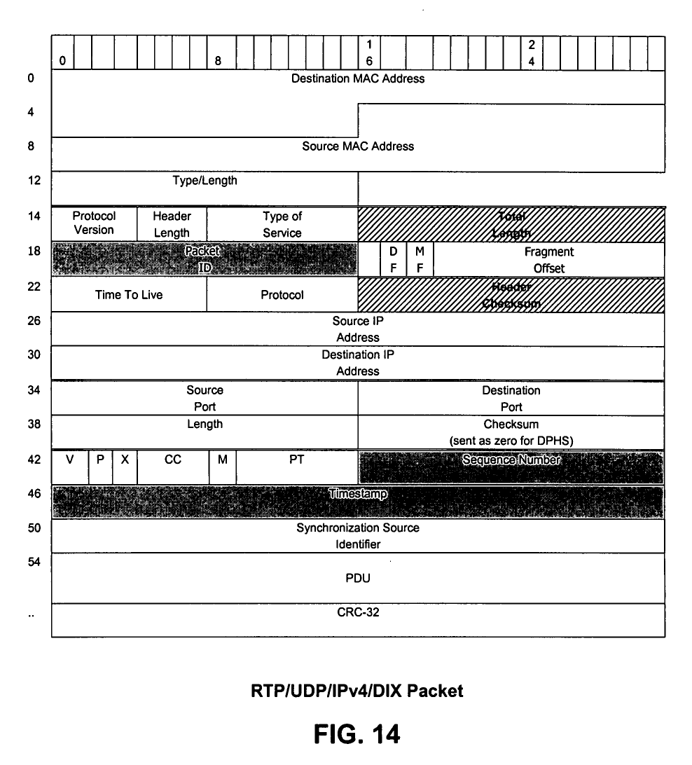

An RTP/UDP/IPv4/DIX header is illustrated in FIG. 14. The RTP/UDP/IPv4/DIX header contains 20 bytes of IPv4 header, 8 bytes of UDP header, and 12 bytes of RTP header. If the IPv4 header contains options, the CM cannot perform DPHS on the packet.

The RTP/UDP/IPv4/DIX header contains static fields, connection static fields, and dynamic fields. Because RTP headers have less dynamic fields than TCP headers, the CM can suppress most of the RTP header. The dynamic Packet ID, Sequence Number, and Timestamp fields of the RTP/UDP/IPv4 header, delta encoded with DPHS, are shaded in FIG. 14. The dynamic Total Length and Header Checksum fields in the IPv4 header, diagonally shaded in FIG. 14, are not transmitted on the communications link, but regenerated by the CMTS from the unsuppressed header. For DPHS purposes, the UDP Checksum field is not considered dynamic. The UDP Checksum field is always sent as a value of zero.

3.4.1 RTP/UDP/IPv4/DIX Control bytes

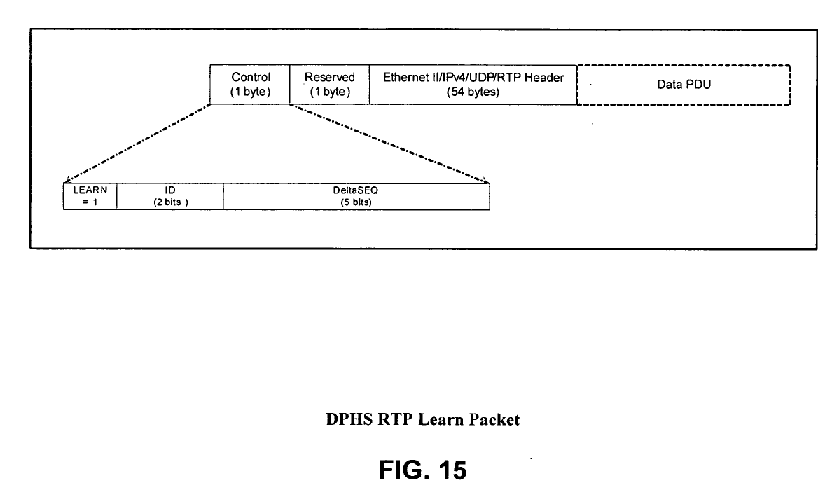

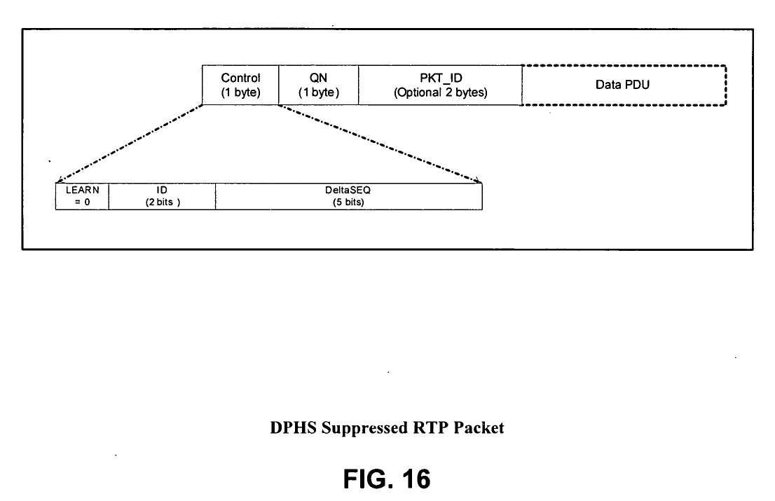

In an embodiment, the format of the DPHS RTP Learn Packet is shown in FIG. 15 and Table 3-10. In an embodiment, the format of the DPHS RTP Suppressed Packet is shown in FIG. 16 and Table 3-10.

TABLE 3-10
DPHS RTP/UDP/IPv4/DIX Suppressed Packet

| Field | Usage | Size |
|---|---|---|
| Learn | 1 = The Learn bit indicates that the remainder of the | 1 bit |
| | control byte can be ignored, and that an entire | |
| | 54-byte DIX/IPv4/TCP header is included in the | |
| | packet and should be used to replace the current | |
| | template header. The second byte in the data | |
| | stream is reserved and should be discarded. | |
| | 0 = DPHS suppression has been applied. | |
| ID | 11 = The IPv4 Packet ID Field does not increment. | 2 bits |
| | 10 = The two-byte delta field PKT_ID, is a 2-byte | |
| | value to be copied to the IPv4 Packet ID field of | |
| | the template header. | |
| | 01 = Increment the IPv4 Packet ID Field of the | |
| | template header by 0x0100. | |
| | 00 = Increment the IPv4 Packet ID Field of the | |
| | template header by 0x0001. | |
| DeltaSEQ | Delta Sequence: This field is the difference between | 5 bits |
| | the new sequence number and the previous sequence | |
| | number in the RTP Sequence Number field. | |
| QN | Quantization Number: This field is the difference | 1 |
| | between the new RTP Timestamp and the previous | byte |
| | RTP Timestamp divided by the difference between | |
| | the new RTP Sequence Number and the previous RTP | |
| | Sequence Number. | |
| | $QuantizationNumber = \frac{ΔRTPTimestamp}{ΔRTPSequenceNumber}$ | |
| PKT_ID | Packet ID Change: This field is only included if the | 2 |
| | IPv4 Packet ID field changes by something other than | bytes |
| | 0x0001 or 0x0100 and if the ID bits are set to 10. This | |
| | field is the new IPv4 Packet ID. | |

4. DPHS Configuration and Signaling

The following section describes methodologies and/or techniques that can be applied to IPv6 DPHS. The configuration and signaling mechanism for IPv6 versions of DPHS is the same as that of TCP/IPv4. The CM will initiate a DSC transaction to create three classifiers and corresponding DPHS rule—one to catch TCP/IPv4 traffic not otherwise classified, one to catch TCP/IPv6 traffic not otherwise classified, and one to catch non-TCP/IPv6 traffic not otherwise classified. Each of these DPHS rules will have PHSIs for identifying the suppression instances.

4.1 Registration

DPHS is enabled by both the CM and the CMTS in the registration process. A CM includes support for DPHS in the modem capabilities field sent to the CMTS in the REG-REQ message. The CMTS indicates support for the modem capability in the REG-RSP message. If the CMTS does not support DPHS, the CMTS includes the modem capability, returning a value of “zero” in the REG-RSP message.

DPHS can also be disabled via a MIB override. If DPHS is disabled via the MIB override, the CM does not create service flows containing DPHS Rules. If DPHS is disabled in via the MIB override, the CMTS does not create service flows containing DPHS Rules.

Once both the CM and the CMTS enable DPHS, suppression occurs on any of the aforementioned packet types. To be DPHS suppressible, only Ethernet II (DIX) can encapsulate the IP packet. Suppression using DPHS assumes there is no LLC/SNAP header or 802.1 P/Q tag.

4.2 TCP

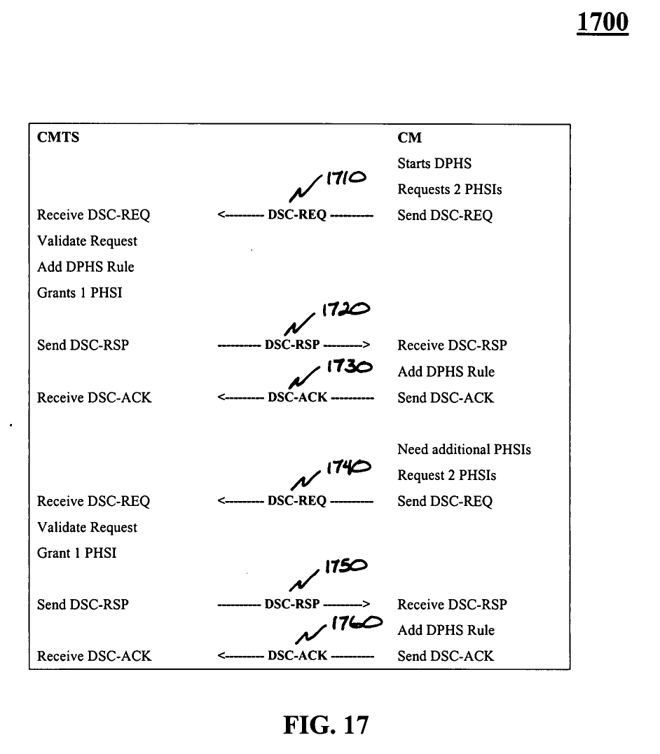

FIG. 17 provides signaling diagram 1700 that illustrates the initiation process to enable DPHS with TCP protocol, according to an embodiment of the invention. The CM creates a classifier as defined in the DOCSIS specifications and a PHS rule before it can start using DPHS. As shown in step 1710, the CM sends a Dynamic Service Change (DSC) message to the CMTS to create the classifier and PHS rule. In particular, the CM creates a PHS rule and a classifier that catches TCP traffic that is not otherwise classified. The DSC specifies the SFID for the primary upstream flow for the Classifier and PHS settings. The Classifier contains settings requesting an IP Protocol Type of TCP. Additionally, the PHS settings trigger the CMTS to provide DPHS PHSI(s). The CM supports no more than one DPHS rule for TCP suppression.

In step 1720 the CMTS responds to the DSC-REQ with a DSC-RSP message creating the Classifier and PHS Rule. If the DSC-REQ contained a request for PHSI(s), it is up to the CMTS to determine the number of PHSIs that it provides the CM.

When the CM receives the DSC-RSP from the CMTS, the CM does the required error checking and sends a DSC-ACK message, as illustrated in step 1730. If any of the error checks fail, the CM sends a DSC-ACK with a confirmation code of “8,” Reject Required Parameter Not Present, and does not install or use DPHS. Additionally, the CM checks the PHS Settings for DPHS PHSI(s).

The CM may request additional PHSIs. To request additional PHSIs, the CM sends a DSC-REQ to the CMTS with the TLV indicating the desired number of PHSIs, as illustrated in step 1740. Upon receipt of the DSC-REQ message, the CMTS validates the request and determines whether to grant an additional PHSI. In step 1750 the CMTS responds with a DSC-RSP message to the CM. In step 1760 the CM acknowledges the DSC-RSP message with a DSC-ACK message. Similarly, if the CM has more PHSIs than necessary, the CM may release any number of the PHSIs. To release the PHSIs, the CM sends a DSC-REQ to the CMTS requesting that the CMTS release the specified PHSI(s).

The CM uses the PHSI(s) granted by the CMTS to identify individual TCP stream(s) in DPHS. When the CM has an unused PHSI, it looks for a TCP stream for dynamic suppression. After the CM identifies a TCP stream for DPHS, the CM transmits the TCP packet in the stream in its entirety with the DPHS TCP Control bytes prepended to the stream. The DPHS TCP Control bytes have a control bit, the Learn Bit, that indicates to the CMTS that this TCP header needs to be learned. If the CM has no unused PHSI, it sends the packets in the TCP stream without any suppression.

When it sees the Learn Bit set in the DPHS TCP Control bytes, the CMTS learns the TCP/IP/DIX header; it takes the current TCP/IP/DIX header of the packet and stores a copy of it in a template header. The CMTS uses the template header as a reference in the reconstruction of the suppressed fields of the TCP/IP/DIX header. Once the CMTS learns the TCP header, subsequent packets may be sent in a compressed format.

The CM retrieves the next packet in the TCP connection stream. The CM then identifies the fields that have changed from the previous transmitted packet. The CM determines which TCP/IP/DIX header values are present in the compressed packet based on the fields that have changed. The CM generates the compressed TCP packet and prepends the DPHS TCP Control bytes to the compressed TCP packet. The CM communicates the changes to the CMTS in the DPHS TCP Control bytes.

Based on the fields that changed from the previous transmitted values, one of two actions will occur. The CM may transmit the TCP packet unsuppressed, or the CM may suppress the TCP header, replacing the 54-byte TCP/IP/DIX header with two or more fields and prepending it with DPHS TCP Control bytes.

The CM determines if there are more TCP packets in the TCP connection stream to be transmitted. If there are more TCP packets to be transmitted, the CM retrieves the next packet, identifies the fields that have changed and goes through the same process. If there are no more TCP packets to be transmitted and additional PHSIs, the CM identifies a new TCP stream. If there are no more TCP packets in the current TCP connection stream and no additional PHSIs, the CM transmits TCP packets in other TCP connection streams unsuppressed.

The CMTS determines whether the received TCP packet is to be stored in a header template by checking the value of the Learn Bit of the DPHS TCP Control bytes. If the Learn Bit is set, the CMTS learns the current 54-byte TCP/IP/DIX header of the received TCP packet and stores the 54-byte TCP/IP/DIX header for future reference as a header template. If the Learn Bit is not set, the CMTS reads the DPHS TCP Control bytes. The CMTS reconstructs the header based on the information in the DPHS TCP Control bytes, updates the TCP/IP header flags, updates the changed fields in the stored header template, recalculates the IP Total Length field, and calculates the new IP header checksum using the updated fields in the template header. The CMTS then places the restored TCP header in front of any received data from the received TCP packet. At this point, the packet is completely restored to its original format and can be transmitted over an IP network.

4.2.1 Error Cases

If the CM receives two identical packets, the CM assumes that the second packet is a retransmitted packet. The CM does not perform DPHS on a second identical packet.

The CM may only perform DPHS on TCP packets in which the acknowledgement flag bit is set. If the Acknowledgement flag in the TCP header is not set, the CM does not perform DPHS on the packet.

If the Urgent Bit of the TCP header is not set but the Urgent Pointer of the TCP header changes, the CM sends the packet unsuppressed with the Learn bit of the DPHS TCP Control bytes set.

The CM does not suppress packets in which the IP Header Length, IP TOS, IP Protocol, TCP Time to Live, and TCP Protocol bits change. The CM does not suppress packets in which the IP Fragmentation bit is set or the Fragment Offset Value is not 0. The CM does not suppress packets in which the Reset bit is set.

4.2.2 CM-CMTS Example Implementation Summary Methods

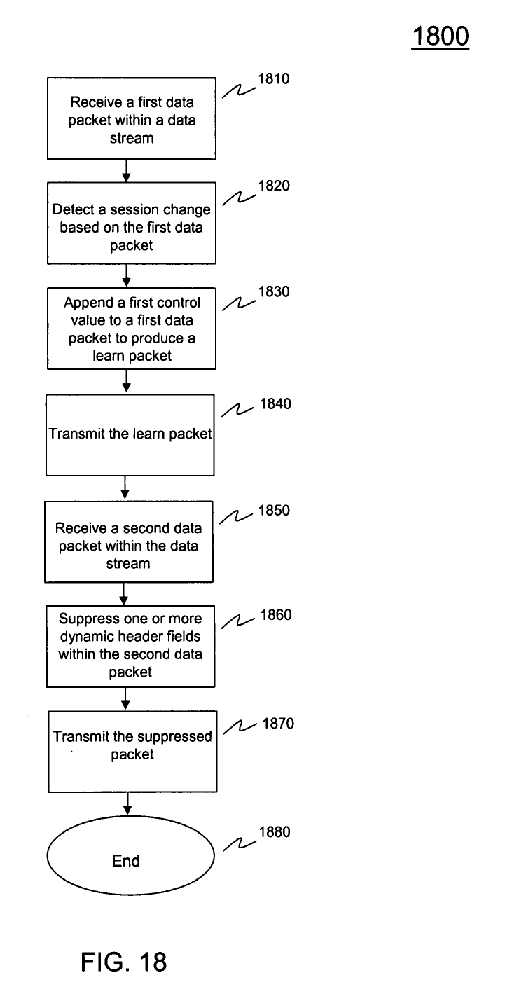

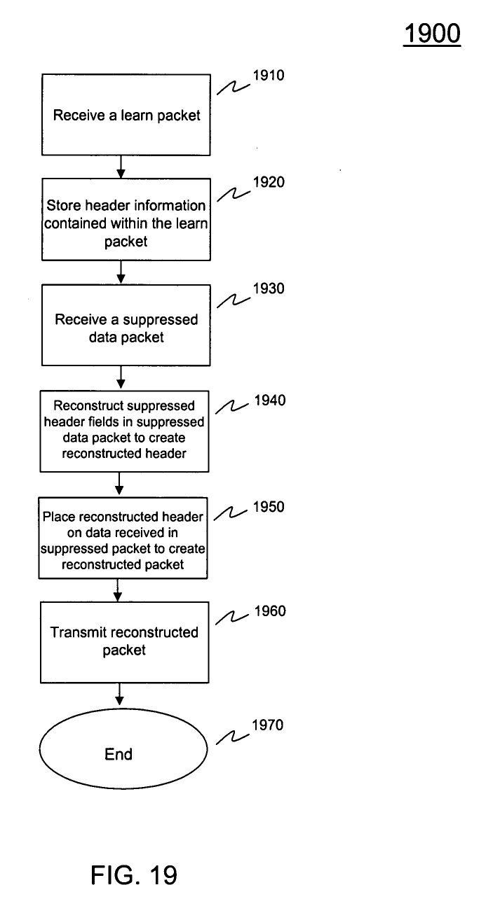

FIGS. 18 and 19 summarize the above transmission process from the perspective of a CM and CMTS, respectively, according to embodiments of the invention. The use of a CM a source device and a CMTS as a destination device is exemplary and not intended to limit the scope of the invention. The invention can be used with other types of source and destination devices over wireless networks, wireline networks or a network composed of both wireline and wireless network elements.

FIG. 18 provides a flowchart of method 1800 for transmitting suppressed packets from the perspective of the CM, according to an embodiment of the invention. Message types can include, but are not limited to, IPv6/DIX, TCP/IPv6/DIX, TCP/IPv4/DIX, and RTP/UDP/IPv4.

Method 1800 begins in step 1810. In step 1810 a first data packet within a data stream for transmission is received. For example, a CM can receive a data stream from a consumer device, such as a personal computer that is coupled to the CM. In step 1820 a session change based on the first data packet received is detected. For example, the CM can determine that a new session has begun based on the header fields received in the data packets from the data received from the consumer device.

In step 1830 a first control value is appended to the first data packet to produce a learn packet. In an embodiment, the learn packet includes information that enables suppression of fields within data packets. Example learn packets are described with respect to FIGS. 2, 5, 6 and 10 herein.

In step 1840 the learn packet is transmitted. For example, a CM can transmit the learn packet to a CMTS. In step 1850 a second data packet within the data stream is received. For example, the CM receives a second data packet from a consumer device.

In step 1860 one or more dynamic header fields within the second data packet are suppressed to produce a suppressed packet having a suppressed header. Example suppressed packets are shown in FIGS. 3, 7, 11 and 13, herein. In an embodiment a delta value indicating a change in at least one of the dynamic header fields from a corresponding header field in a previously transmitted data packet is computed. In this situation the changed dynamic field is suppressed and the delta value is included in the suppressed header. For example, referring to FIG. 3, the delta values can include a DeltaSEQ value and/or a DeltaACK value.

In an alternative embodiment, both dynamic and static header fields within the data packets can also be suppressed.

In step 1870 the suppressed packet is transmitted. For example, the CM transmits the suppressed packet to the CMTS. In step 1880 method 1800 ends. As described above, steps 1850 through 1870 will continue until all data packets within a data stream are sent.

FIG. 19 provides a flowchart of method 1900 for receiving suppressed packets from the perspective of the CMTS, according to an embodiment of the invention. Message types can include, but are not limited to, IPv6/DIX, TCP/IPv6/DIX, TCP/IPv4/DIX, and RTP/UDP/IPv4.

Method 1900 begins in step 1910. In step 1910 a learn packet is received. The learn packet includes header information and information that enables suppression of header fields within data packets within a data stream. For example, a CMTS can receive a learn packet from a CM. Example learn packets are described with respect to FIGS. 2, 5, 6 and 10 herein.

In step 1920 header information contained within the learn packet is stored. For example, the CMTS can store the header information. Following the storing of header information contained within the learn packet, in step 1930 a suppressed data packet within the data stream is received. One or more dynamic header fields are suppressed within the suppressed data packet.

In step 1940 the suppressed dynamic header fields within the data packet are reconstructed to create a reconstructed header. In an embodiment reconstruction of the suppressed dynamic header fields is based on information in control bytes received within the suppressed data packet and the stored header template. For example, the CMTS can use the DeltaSEQ value to adjust the packet sequence number and/or use the DeltaACK value to adjust the acknowledgment number. By using this information, the CMTS can update the changed fields in the stored header information based on the control bytes in the received suppressed data packet. The reconstruction process further includes recalculating an IP total length field within the reconstructed data packet and calculating a new IP header checksum for the updated fields in the template header.

In step 1950 the reconstructed header is placed on the received data within the received suppressed data packet to create a reconstructed data packet. The reconstructed data packet includes data contained within the received data packet and the reconstructed header.

In step 1960 the reconstructed data packet is transmitted. For example a CMTS can transmit the reconstructed data packet to an Internet router. In step 1970 method 1900 ends.

4.3 RTP

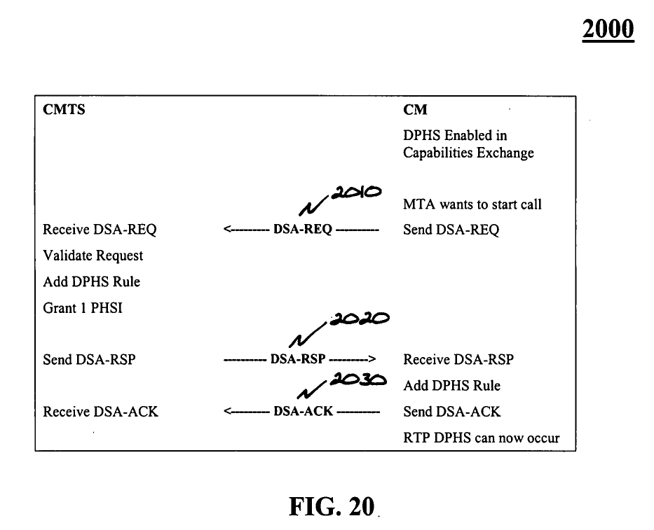

FIG. 20 provides signaling diagram 2000 that illustrates the initiation process to enable DPHS with RTP protocol, according to an embodiment of the invention. In order to start using DPHS to suppress RTP/UDP/IP/DIX packets, it is necessary to include the DPHS information in the Dynamic Service Add (DSA) transaction in which the upstream service flow is created. The DSA, initiated by either the CM or the CMTS, specifies the Classifier and PHS settings of the new upstream service flows. The Upstream Service Flow Settings contains upstream flow settings specifying an upstream scheduling type of Unsolicited Grant with Piggyback, and the Classifier contains IP settings specifying an IP Protocol Type of RTP. Additionally, the PHS settings either provide or ask the CMTS to provide a DPHS PHSI. In the case of signaling diagram 2000, the CM sends a DSA-REQ to the CMTS, as illustrated in step 2010, to initiate the registration process and request a DPHS PHSI. The CM may have multiple DPHS rules for RTP suppression.

In step 2020, the CMTS sends a DSA-RSP message to the CM. The DSA-RSP message creates the Upstream Service Flow, Classifier, and PHS Rules. It is necessary that all the required error checking be done on the DSA messages. In step 2030, the CM responds with a DSA-ACK. At this point, RTP DPHS can now occur. If any of the error checks fail, it is necessary to send a DSA-ACK with a confirmation code of “8”, Reject Required Parameter Not Present, and not use DPHS.

Initially, the CM sends one or more unsuppressed full RTP headers with the Learn Bit of the prepended DPHS RTP Control Bytes indicating that CMTS is to take the current RTP/UDP/IP/DIX header and store it as a template header. The first order difference in the RTP Timestamp field, the quantization value, is used to verify that the CMTS will reconstruct the RTP header correctly. This is necessary in order to ensure that no packets are lost due to suppression. If it determines that reconstruction of the RTP header would be incorrect, the CM SHOULD send a full header with the Learn Bit enabled in the prepended DPHS RTP Control Bytes. If it confirms proper reconstruction, the CM may send a compressed RTP header consisting of the DPHS RTP Control Bytes in place of 54-byte RTP/UDP/IP/DIX header.

To determine whether proper reconstruction will occur, the CM determines a per-packet “quantization” value based on the difference between the RTP Timestamp fields of two consecutive RTP packets divided by the difference between the RTP Sequence Number fields; this value is shown in Equation 5-1 below. The quantization value is then multiplied by the difference in RTP Sequence Numbers and added to the previous RTP Timestamp to provide a value that should be equal to the current RTP Timestamp, called Test Timestamp in Equation 5-2. If the Test Timestamp value does not equal the current RTP Timestamp, the CM SHOULD transmit the complete RTP header along with the DPHS RTP Control Bytes containing an enabled Learn bit. If the Test Timestamp value equals the current RTP Timestamp, the CM may send a compressed RTP header consisting of the DPHS RTP Control Bytes in place of the 54-byte RTP/UDP/IP/DIX header.

$$\begin{matrix}Equation 5 \text{-} 1 \text{:} & \\ \begin{matrix}QuantizationValue = \frac{CurrentTimestamp - PreviousTimestamp}{\begin{matrix}CurrentSequenceNumber - \\ PreviousSequenceNumber\end{matrix}} \\ = \frac{Δ Timestamp}{Δ SequenceNumber}\end{matrix} & \\ Equation 5 \text{-} 2 \text{:} & \\ TestTimestamp = PreviousTimestamp + QuantizationValue \cdot Δ SequenceNumber & \end{matrix}$$

The CMTS determines whether the received RTP packet is to be learned by checking the value of the Learn Bit of the DPHS RTP Control bytes. If the Learn Bit is set, the CMTS learns the current 54-byte RTP/UDP/IP/DIX header of the received RTP packet and stores the 54-byte RTP/UDP/IP/DIX header for future reference as a header template. If the Learn Bit is not set, the CMTS reads the DPHS RTP Control bytes. Based on the DPHS RTP Control bytes, the CMTS reconstructs the header, updates the changed fields in a stored header template, recalculates the IP Total Length field, and calculates the new IP header checksum using the updated fields in the header template. The CMTS then places the restored RTP header in front of any received data from the received RTP packet. At this point, the packet is completely restored to its original format and can be transmitted over an IP network.

4.3.1 Error Cases

The CM does not suppress packets in which the IP Header Length, IP TOS, and IP Protocol bits change. The CM does not suppress packets in which the IP Fragmentation bit is set or the Fragment Offset Value is not 0. The CM does not suppress packets in which the Reset bit is set.

4.4 DPHS State Transition Diagrams

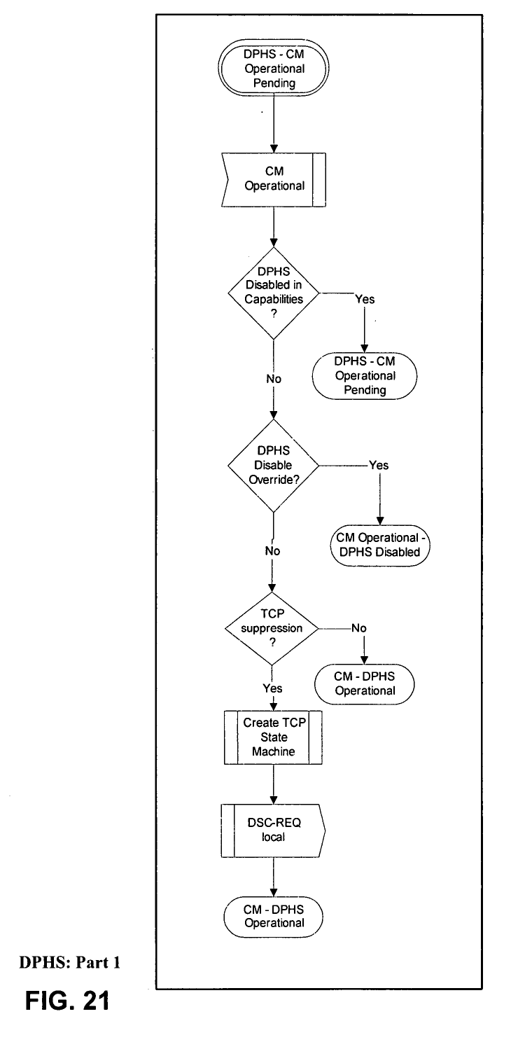

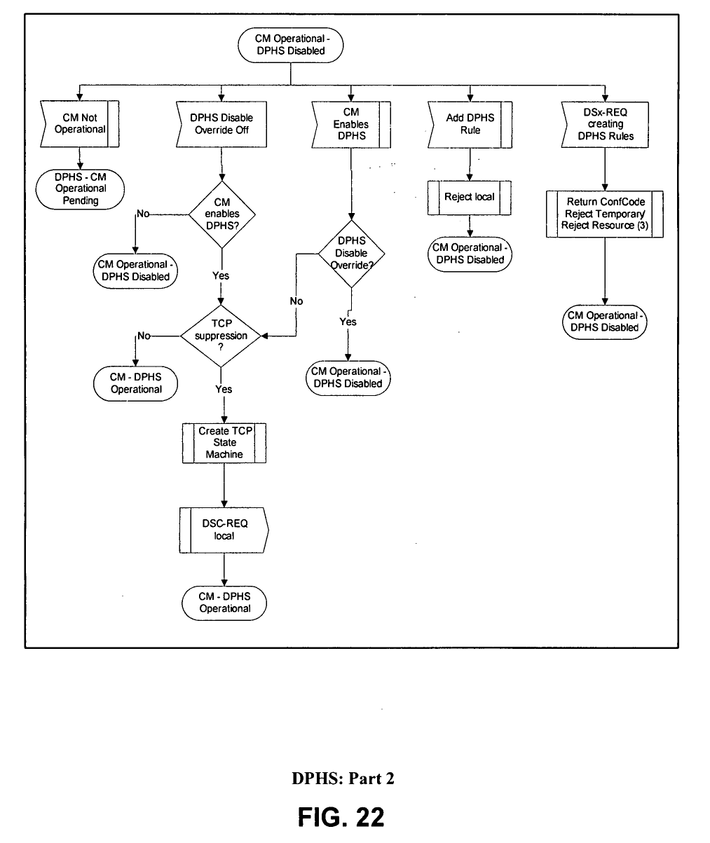

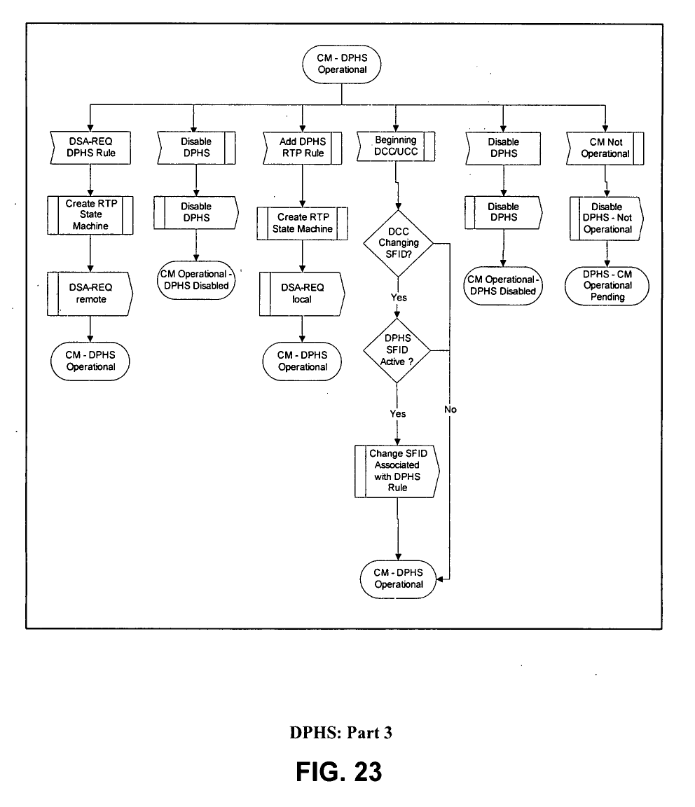

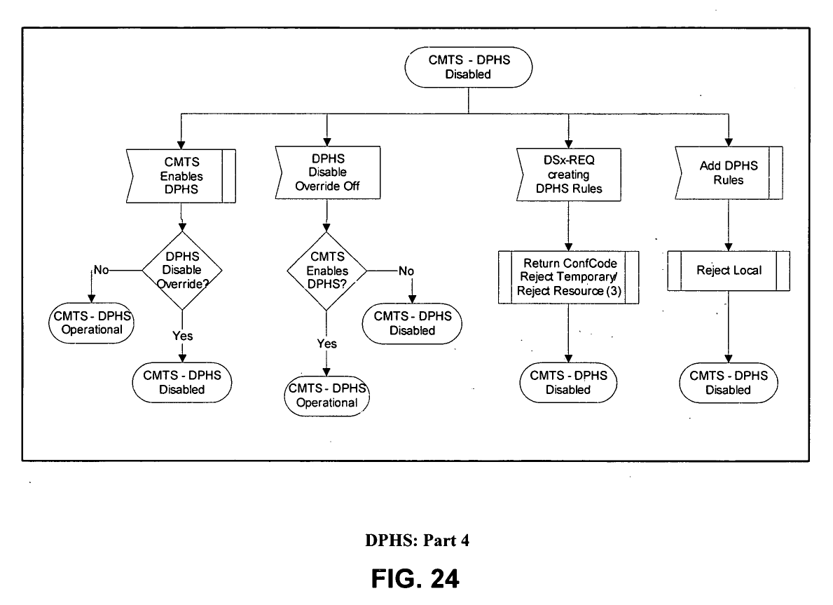

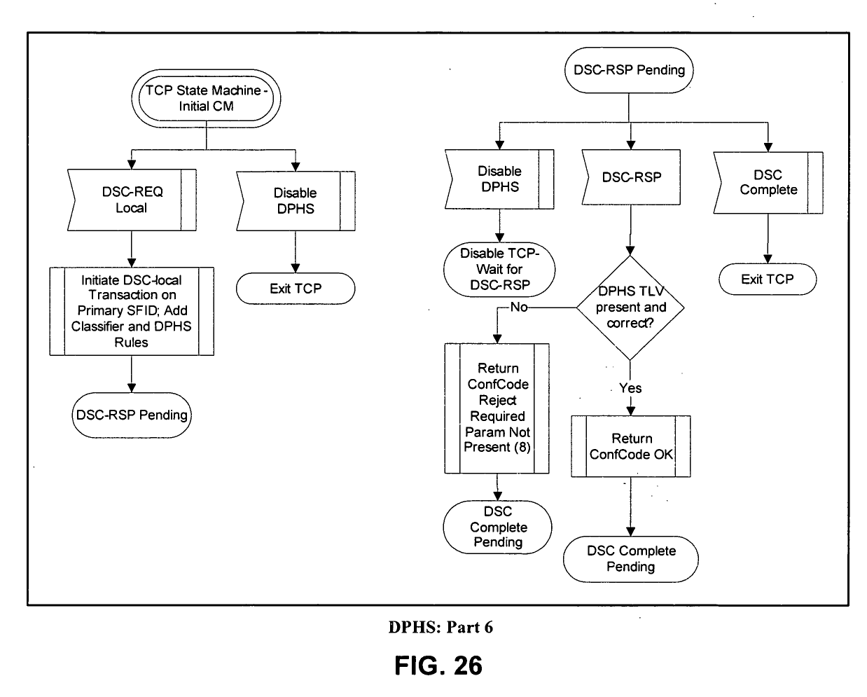

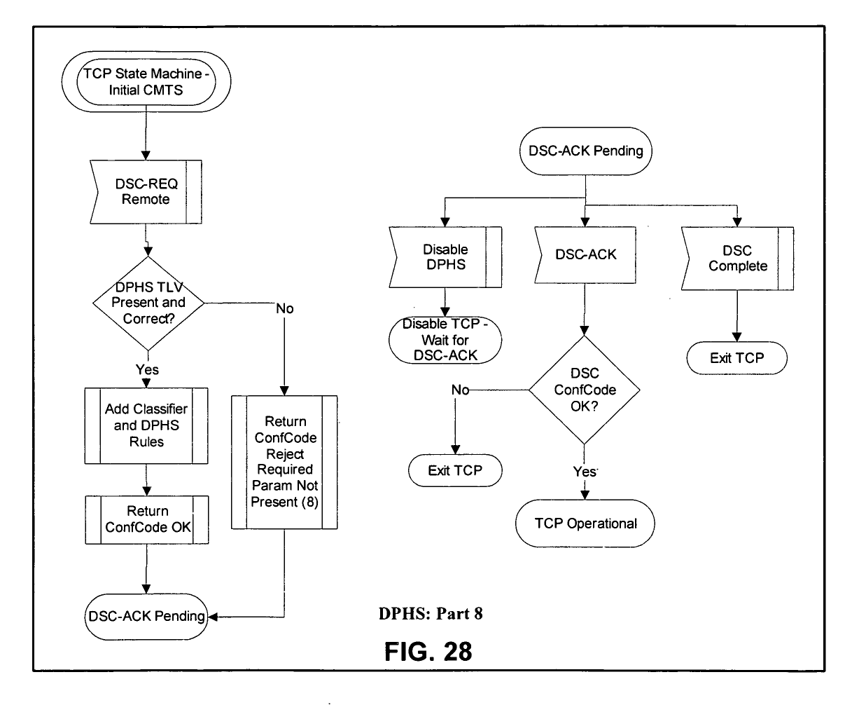

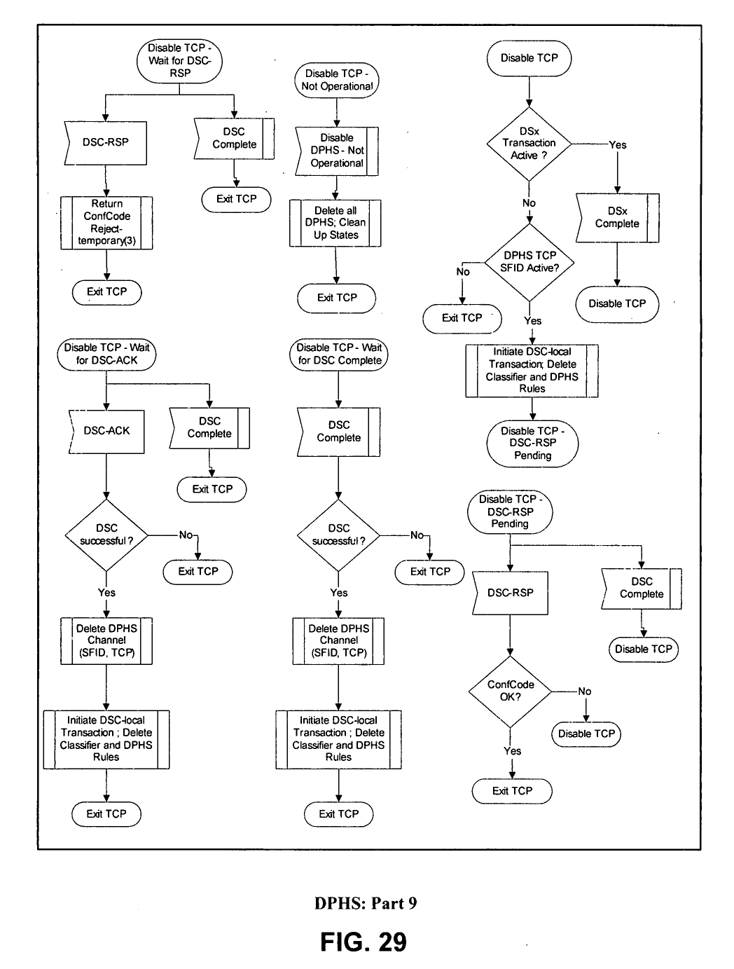

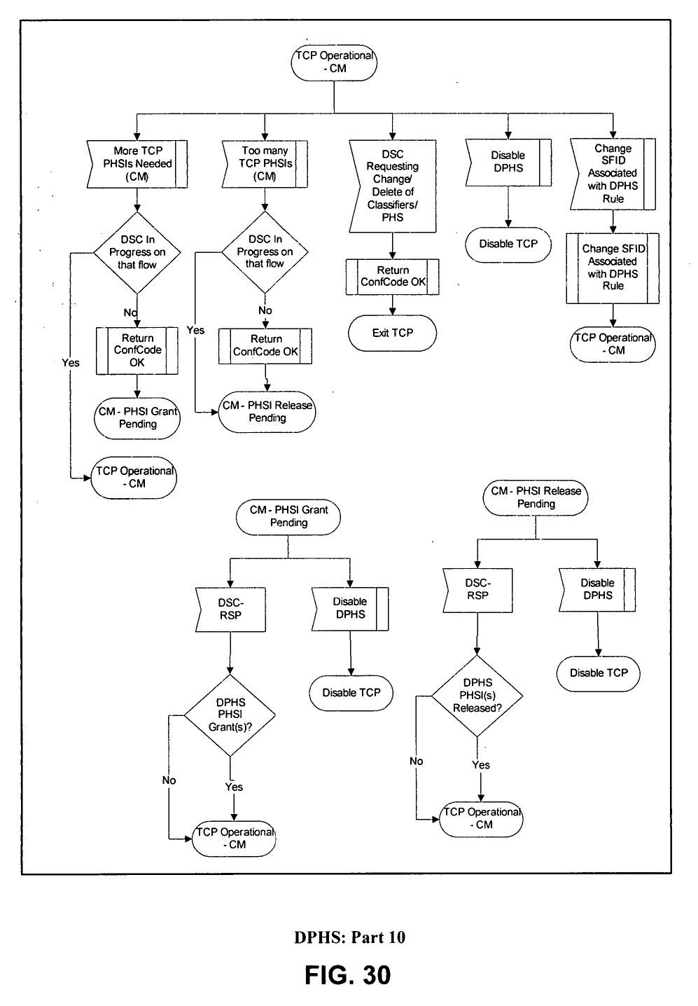

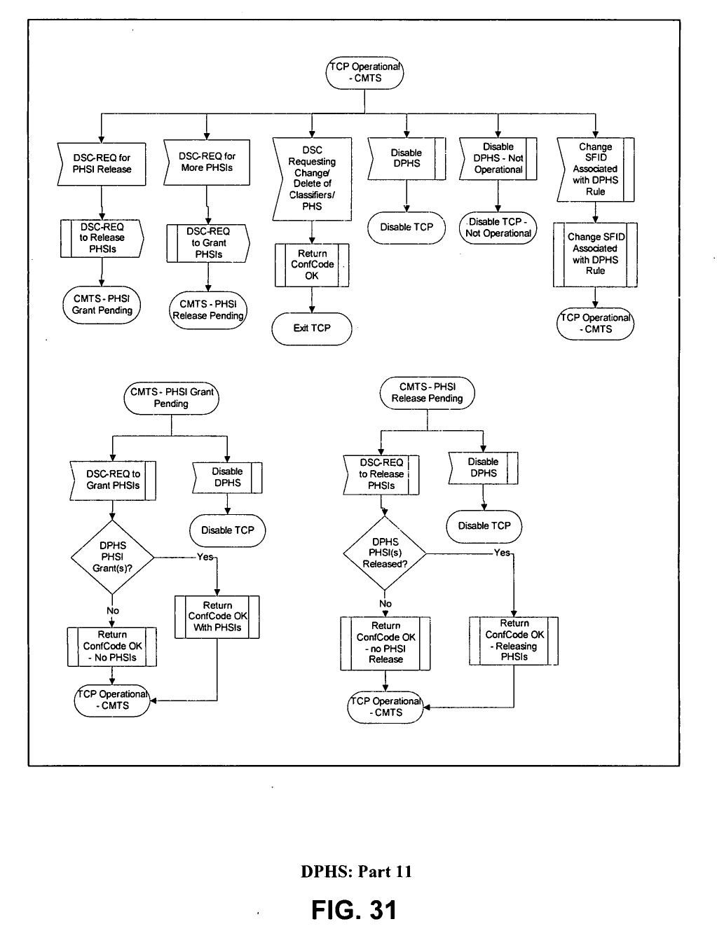

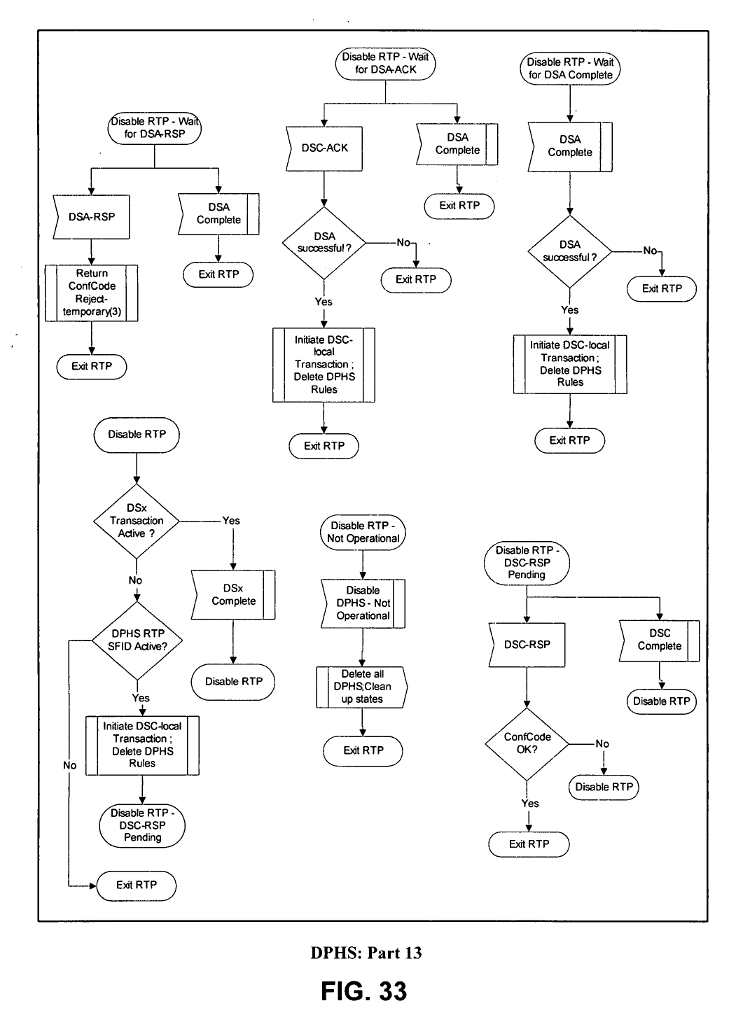

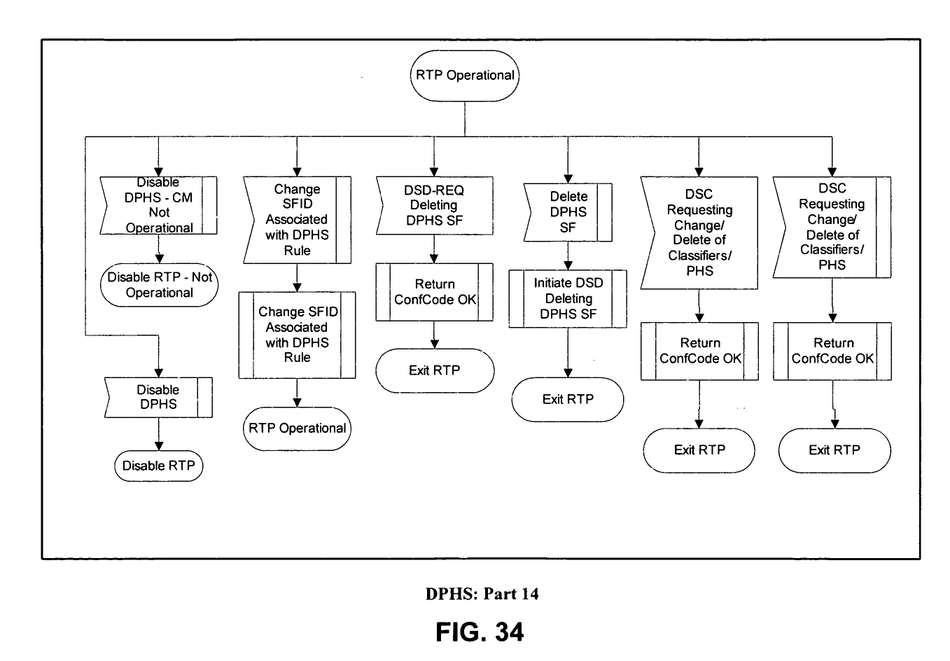

FIGS. 21-34 illustrate state transition diagrams for the operational flow of DPHS, according to embodiments of the invention. The states for the CM and CMTS are shown in FIGS. 21-25. These states are top level states that initiate the state machines for the TCP and/or RTP suppression.

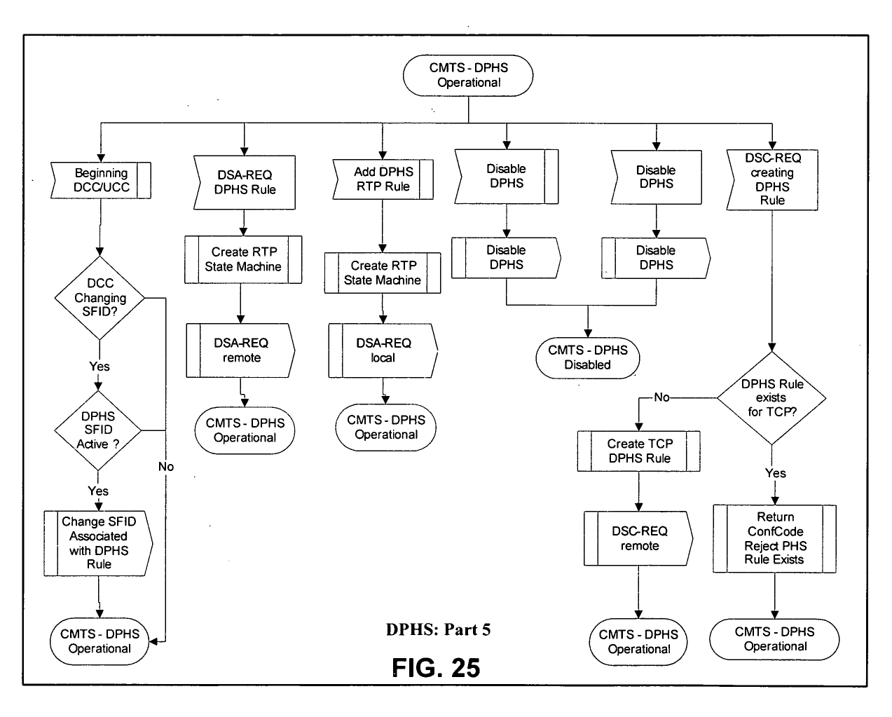

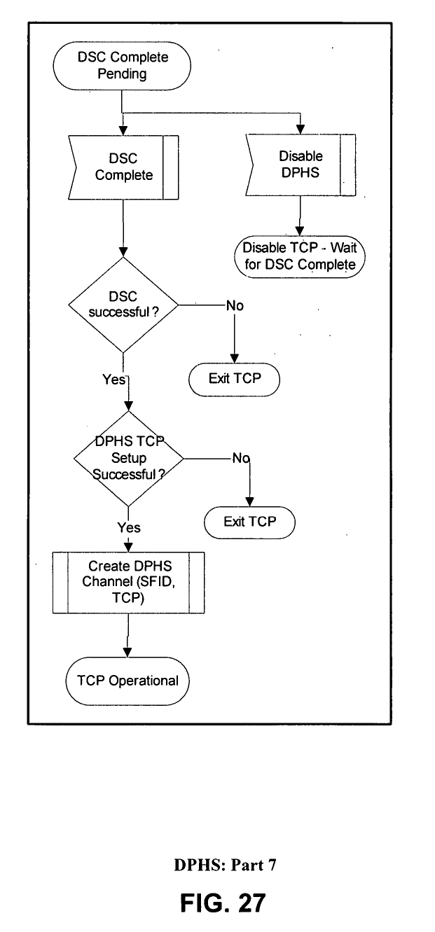

The CM can have one TCP state machine active at a time. The CMTS can have one TCP state machine active per CM. The TCP state machines (FIGS. 25-30) are separate for the CM (FIGS. 25, 26, 28, and 29) and the CMTS (FIGS. 27, 28, and 31). This is because the CM initiates the TCP state machine and the states of the CM and CMTS are not the same.

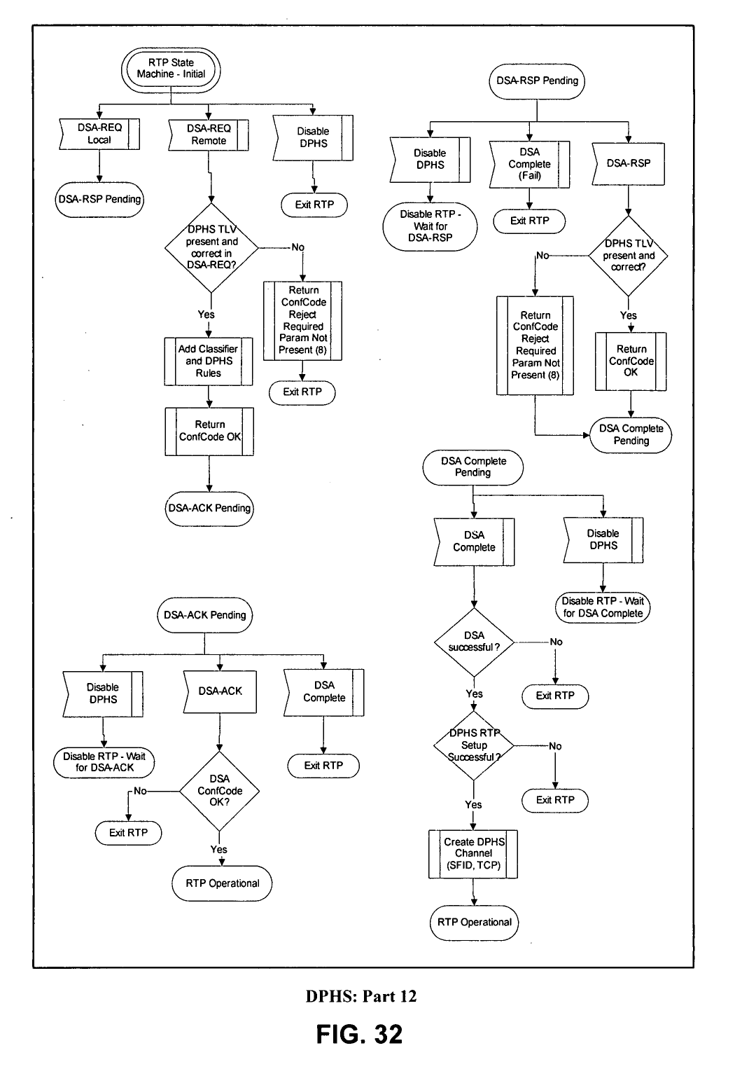

The CM can have multiple RTP state machines active at a time. The CMTS can have multiple RTP state machines active per CM. The RTP state machines are identical for both the CM and the CMTS. They are shown in FIGS. 32-34. The RTP state machines are identical for the CM and the CMTS because the DSA transaction initiating the DPHS RTP Suppression can come from either the CM or the CMTS.

4.5 Dynamic Payload Header Suppression Examples

The following example describes specific codings necessary for CM and CMTS messaging based on DOCSIS. The example is intended to be illustrative, and not limit the scope of the invention.

4.5.1 TCP Example

The CM includes the DPHS modem capability field in the REG-REQ message. The CMTS includes the DPHS modem capability in the REG-RSP message, returning a value of “one”. The CM then sends a Dynamic Service Change (DSC) message to the CMTS. The DSC message contains:
The SFID for the primary upstream flow for the Classifier and PHS settings.
IP settings specifying an IP Protocol Type of TCP (0x06)
DSC Change action of Add (0)
PHS settings with—
   A DSC Change action of Add (0)
   A PHS Size of 54
   A PHS Mask of 54 1 bits (6 bytes of 0xff, with one byte of 0xfc)
   PHS Verify Enabled (0)
   PHS Field of 54 bytes of 0xff
   DPHS request of two PHSIs.
      4.5.2 RTP Example

The CM includes the DPHS modem capability field in the REG-REQ message. The CMTS includes the DPHS modem capability in the REG-RSP message, returning a value of “one”. After a period of time, the CM gets an indication from an attached MTA that it should start a Dynamic Service Add (DSA) transaction. The CM then sends a DSA-REQ message to the CMTS. The DSC message contains:
The Upstream Scheduling Type of UGS with Piggyback
The parameters necessary for creating a phone call (UGS parameters, etc.)
PHS settings PacketCable Specific Settings for DPHS. Note: PacketCable has very specific settings defined when using PHS. The specific settings for DPHS will also have to be added. They will need to include the appropriate information to suppress the 54-byte header and to request for a PHSI to be used.
   5. Changes to DOCSIS 2.0 Specification

Within the context of CM and CMTS communication, in order to implement the present invention several changes to DOCSIS 2.0 specification are needed. These changes are provided to further illustrate the invention and describe an implementation. The changes are not intended to limit the scope of the invention to only CM to CMTS communications.

5.1 New Upstream Scheduling Type—UGS with Piggyback

The creation of a new upstream scheduling type is necessary. The new upstream scheduling type is an unsolicited grant service with support for piggyback requests, Unsolicited Grant with Piggyback (UGSP). Like UGS, UGSP is intended to support real-time service flows that generate fixed size data packets on a periodic basis, such as Voice over IP. In this service, restricted to RTP DPHS, the CMTS provides fixed size grants sized to fit the RTP/UDP/IP/DIX learn packets used in DPHS when compressing RTP/UDP/IP/DIX packets; the RTP/UDP/IP/DIX learn packets are two bytes larger than the RTP/UDP/IP/DIX packets sent in Voice over IP applications.

However, in order to prevent unused bytes of UGS grants from wasting bandwidth, UGSP allows piggyback requests to be used to communicate to the CMTS the length of the suppressed RTP/UDP/IP/DIX packet. After the CM verifies that the CMTS will properly reconstruct the RTP DPHS suppressed packet, the CM includes a piggyback request sized for the suppressed packet. If it receives a piggyback request in the packet, the CMTS reduces the unsolicited grant size to the size requested by the CM. If no piggyback is present in the grant, the CMTS returns the unsolicited grant size to the one provisioned via registration or dynamic service.

Like UGS, the Request/Transmission Policy setting is such that the CM is prohibited from using any contention request or request/data opportunities and the CMTS is not to provide any unicast request opportunities. The key service parameters are the Unsolicited Grant Size, the Nominal Grant interval, the Tolerated Grant Jitter and the Request/Transmission Policy.

5.2 DSC Changes

Modifications to the Dynamic Service Change portion of the DOCSIS 2.0 specification will also be necessary to implement the present invention. The DSC is used to modify the flow parameters associated with a service flow; this proposal extends the potential modifications to include changing PHS Rules to request and release PHSIs for DPHS. This extension is specific only to PHS Rules when DPHS is enabled.

The CM may use the “Change PHS Rule” command to request or release PHSI(s) for a specified DPHS Rule. The CM does not use the “Change PHS Rule” for any purpose other than requesting or releasing DPHS PHSI(s). The CMTS does not use the “Change PHS Rule” command when initiating a DSC. The CMTS rejects a DSC-REQ that uses the “Change PHS Rule” command for anything other than requesting or releasing PHSI(s) in DPHS.

5.3 Modem Capabilities

The CM will indicate support for DPHS in the Modem Capabilities.

5.3.1 DPHS Support

The value is the DPHS support of the CM.

| Type | Length | Value |
|---|---|---|
| 5.14 | 1 | 0 = DPHS is not supported |
| | | 1 = DPHS is supported |

5.4 Annex C Encodings
5.4.1 Payload Header Suppression Encodings
5.4.1.1 Dynamic Service Change Action

When received in a Dynamic Service Change Request, this indicates the action that is taken with this payload header suppression byte string.

| Type | Length | Value |
|---|---|---|
| 26.5 | 1 | 0 - Add PHS Rule |
| | | 1 - Set PHS Rule |
| | | 2 - Delete PHS Rule |
| | | 3 - Delete all PHS Rules |
| | | 4 - Change PHS Rule (Request or Release PHSI(s)) |
| | | 5 - Send Learn packet |

The “Set PHS Rule” command is used to add specific TLVs to a partially defined payload header suppression rule. A PHS rule is partially defined when the PHSF and PHSS values are not both known. A PHS rule becomes fully defined when the PHSF and PHSS values are both known. Once a PHS rule is fully defined, “Set PHS Rule” does not be used to modify existing TLVs.

The “Delete all PHS Rules” command is used to delete all PHS Rules for a specified Service Flow. See Section 8.3.15 for details on DSC-REQ required PHS parameters when using this option.

The “Change PHS Rule” command is only to be used to request or release PHSI(s) for a specified DPHS Rule. It is not to be used to many any other changes to the PHS Rule.

5.4.2 Dynamic Payload Header Suppression Rule Encodings

5.4.2.1 PHSI Request

This field defines the number of PHSIs that the CM requests for Dynamic Payload Header Suppression.

| Type | Length | Value |
|---|---|---|
| 26.12 | 1 | 1-255 |

5.4.2.2 PHSI Grant

The value of the field specifies the PHSI(s) that the CMTS grants a CM for Dynamic Payload Header Suppression.

| Type | Length | Value |
|---|---|---|
| 26.13 | N | PHSI[0], PHSI[1], . . . , PHSI[n] |

5.4.2.3 PHSI Release

This field is used by the CM to notify the CMTS to release PHSIs.

| Type | Length | Value |
|---|---|---|
| 26.14 | N | <num PHSIs>, <PHSIs to release> |

6. Exemplary System Implementation

FIGS. 1-34 are conceptual illustrations allowing an easy explanation of the present invention. It should be understood that embodiments of the present invention could be implemented in hardware, firmware, software, or a combination thereof. In such an embodiment, the various components and steps would be implemented in hardware, firmware, and/or software to perform the functions of the present invention. That is, the same piece of hardware, firmware, or module of software could perform one or more of the illustrated blocks (i.e., components or steps).

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention is implemented using software, the software can be stored in a computer program product and loaded into computer system using a removable storage drive, hard drive, or communications interface. The control logic (software), when executed by a processor, causes the processor to perform the functions of the invention as described herein.

In another embodiment, aspects of the present invention are implemented primarily in hardware using, for example, hardware components such as application specific integrated circuits (ASICs). Implementation of the hardware state machine so as to perform the functions described herein will be apparent to one skilled in the relevant art(s). In yet another embodiment, the invention is implemented using a combination of both hardware and software.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Moreover, it should be understood that the method, system, and computer program product of the present invention could be implemented in any multi-nodal communications environment governed by centralized nodes. The nodes include, but are not limited to, cable modems, set-top boxes, and headends, as well as communication gateways, switches, routers, Internet access facilities, servers, personal computers, enhanced telephones, personal digital assistants (PDA), televisions, or the like. Thus, the present invention should not be limited by any of the above-described exemplary embodiments, but should be defined only in accordance with the following claims and their equivalents.

What is claimed is:

1. A method of transmitting a data stream from a subscriber station to a base station in a wireless communication system, comprising:
receiving from a data stream a first data packet for transmission to the base station;
detecting a session change based on the first data packet;
combining a first control value and the first data packet to provide a learn packet, wherein the learn packet includes information that enables suppression of fields in data packets;
transmitting the learn packet;
receiving from the data stream a second data packet;
suppressing one or more dynamic header fields of the second data packet to provide a compressed packet having a compressed header; and
transmitting the compressed packet.

2. The method according to claim 1, wherein suppressing the one or more dynamic header fields includes providing a delta value indicating a difference between at least one of the one or more dynamic header fields and a corresponding header field in a previously transmitted data packet;
suppressing the at least one of the one or more dynamic header fields; and
including the delta value in the compressed header.

3. The method according to claim 2, wherein the delta value includes a Delta Sequence value, a Delta Acknowledgement value, or both a Delta Sequence value and a Delta Acknowledgement value.

4. The method according to claim 1, wherein suppressing the one or more dynamic header fields includes
suppressing at least one of the one or more dynamic header fields;
combining a second control value and the second data packet to enable recalculation of the suppressed at least one dynamic header field; and
including the second control value in the compressed header.

5. The method according to claim 1, wherein suppressing the one or more dynamic header fields includes suppressing one or more dynamic header fields that conform to Version 6 of the Internet Protocol (IPv6).

6. The method according to claim 1, wherein suppressing the one or more dynamic header fields includes suppressing one or more header fields that conform to Version 2 of the Ethernet protocol (DIX).

7. The method according to claim 1, wherein suppressing the one or more dynamic header fields includes suppressing a dynamic header field in a data packet that conforms to a protocol selected from the group consisting of IPv6/DIX, TCP/IPv6/DIX, TCP/IPv4/DIX, and RTP/UDP/IPv4.

8. The method according to claim 1, further comprising:
suppressing a static header field of the second packet to provide the compressed packet.

9. A method of receiving a data stream by a base station from a subscriber station in a wireless communication network, comprising:
receiving a learn packet, wherein the learn packet includes header information and information that enables suppression of header fields in data packets of a data stream;
storing the header information;
receiving a data packet of the data stream in response to storing the header information, wherein one or more dynamic header fields of the data packet are suppressed;
reconstructing the suppressed dynamic header fields of the data packet to provide a reconstructed header; and
combining the reconstructed header and data of the received data packet to provide a reconstructed data packet.

10. The method according to claim 9, wherein reconstructing the suppressed dynamic header fields is based on control bytes of the data packet and the stored header information.

11. The method according to claim 9, further comprising:
updating changed fields of the stored header information in response to receiving the data packet.

12. The method according to claim 9, wherein reconstructing the suppressed dynamic header fields includes calculating an IP total length field of the reconstructed data packet and calculating an IP header checksum for the updated changed fields of the stored header information.

13. The method according to claim 9, wherein reconstructing the suppressed dynamic header fields includes reconstructing one or more dynamic header fields that conform to Version 6 of the Internet Protocol (IPv6).

14. The method according to claim 9, wherein reconstructing the suppressed dynamic header fields includes reconstructing one or more header fields that conform to Version 2 of the Ethernet protocol (DIX).

15. The method according to claim 9, wherein reconstructing the suppressed dynamic header fields includes reconstructing a dynamic header field of a data packet that conforms to a protocol selected from the group consisting of IPv6/DIX, TCP/IPv6/DIX, TCP/IPv4/DIX, and RTP/UDP/IPv4.
